(19) United States
(12) Patent Application Publication
(10) Pub. No.: US 2024/0332585 A1
(43) Pub. Date: Oct. 3, 2024

(54) Systems and Methods for Low-Cost Redox Flow Batteries

(71) Applicant: XL Batteries, Inc., Marlborough, MA (US)

(72) Inventors: Thomas Sisto, Marlborough, MA (US); Anouck Champsaur, Marlborough, MA (US); Paul Evans, Marlborough, MA (US); Anthony Bencivenga, Marlborough, MA (US)

(73) Assignee: XL Batteries, Inc., Marlborough, MA (US)

(21) Appl. No.: 18/593,796

(22) Filed: Mar. 1, 2024

Related U.S. Application Data
(60) Provisional application No. 63/488,373, filed on Mar. 3, 2023.

(51) Int. Cl. H01M 8/18; H01M 8/0213; H01M 8/0221; H01M 8/0273

(52) U.S. Cl. CPC H01M 8/188; H01M 8/0213; H01M 8/0221; H01M 8/0273

(57) ABSTRACT

The disclosure provides batteries that have long-duration or long-lifetime for energy storage applications. In one aspect, the disclosure provides perylene diimide molecules that are water soluble and can be used as energy storage materials. In operation, the perylene diimide molecules are oxidized in an anode chamber and the electrons released in the oxidation process flow to the cathode chamber where they reduce a molecule in the cathode chamber. The perylene diimide molecules in accordance with many embodiments are highly compatible with polymeric materials that are inexpensive and easy to process, hence allowing for significantly reduced manufacturing costs.

### CROSS-REFERENCE TO RELATED APPLICATIONS

The current disclosure claims the benefit under 35 U.S.C. § 119 (e) to U.S. Provisional Patent Application No. 63/488,373 entitled “Systems and Methods for Low-Cost Redox Flow Batteries” filed Mar. 3, 2023. The disclosure of U.S. Provisional Patent Application No. 63/488,373 is hereby incorporated by reference in its entirety for all purposes.

### FIELD OF THE INVENTION

The present invention generally relates to low-cost redox flow batteries; and more particularly to redox flow batteries with mild aqueous electrolytes and battery components of low-cost materials.

### BACKGROUND

In redox flow batteries, electrolyte solutions can be stored in tanks and pumped through an electrochemical cell and back into the tanks. The number of cells (the cell stack) can determine the power output of the system (watts), and the size of the tanks can determine the energy (watt hours). This engineered separation of power and energy is an advantage of flow batteries that enables facile scaling. Vanadium oxide redox flow batteries use highly acidic electrolyte solutions such as electrolytes containing sulfuric acid. In addition, vanadium itself is highly corrosive. As a result, the acidic and corrosive solution components of vanadium oxide redox flow batteries may require the cell fabrication parts be comprised of highly chemically resistant materials. For example, vanadium redox flow batteries may require fluorinated polymers as components of the flow batteries. These specialized materials can be costly to make, especially when scaling up the flow battery production. There is a large need for a redox flow battery for long-duration storage that is both chemically stable with long-lifetime electrolytes as well as compatible with inexpensive and high-throughput manufacturable materials. In order for broad applications of redox flow batteries, new flow battery systems that are compatible with low-cost and mass producible materials may be needed.

### BRIEF SUMMARY OF THE INVENTION

Summarized here and described in detail below are redox flow batteries that are compatible with low-cost and non-highly chemical resistant materials as various components of the batteries. The redox flow batteries in accordance with many embodiments comprise aqueous electrolyte solutions of neutral pH. In several embodiments, the low-cost and non-highly chemical resistant materials are stable in the redox flow batteries working conditions for weeks and months. The mild electrolyte solutions enable the incorporation of non-highly chemical resistant materials for flow battery fabrication that can be scaled up with easy access to materials, reduced costs, and with high throughput manufacturing techniques.

In many embodiments, the electrolyte solutions can include aqueous soluble perylene diimide molecules for charge storage applications, and the aqueous solutions are compatible with materials that are not designated as highly chemically resistant (i.e., non-highly chemical resistant materials). In several embodiments, the electrolyte solutions can include aqueous soluble perylene diimide molecules and aqueous soluble ferrocene molecules for charge storage applications, and the aqueous solutions are compatible with materials that are not designated as highly chemically resistant. The term compatibility is defined as having minimal or no deleterious electrochemical or physical reactions between any components of the cell and electrolyte solutions that would preclude long-duration and multi-year device lifetime.

In many embodiments, the redox flow batteries include a first half-cell comprising an anolyte solution and a second half-cell comprising a catholyte solution. The anolyte solution can include (but is not limited to) an aqueous soluble perylene diimide molecule, or an aqueous soluble perylene diimide derivative. The catholyte solution can include (but is not limited to) an aqueous soluble ferrocene molecule, or an aqueous soluble ferrocene derivative. In several embodiments, one or more of the battery components can be made from non-highly chemical resistant materials. Examples of various battery components include (but are not limited to) electrodes, gaskets, flow frames, bipolar plates, membranes, seals, and tubes. Examples of the low-cost and non-highly chemical resistant materials include (but are not limited to) plastics, rubbers, elastomers, ceramics, glass, metals, metal alloys, membranes, ion exchange membranes, size exclusion membranes, and any combinations thereof. In some embodiments, the battery components can be made from non-fluorinated polymers. In several embodiments the non-fluorinated polymer can include (but is not limited to) a polyolefin, a polyether, polyketone, a polyamide, a polyurea, a natural rubber, or any combinations thereof.

Many embodiments provide non-highly chemical resistant materials that are compatible with working conditions of the redox flow batteries over a range of states of charge (SOCs) in cycling and long-term high SOC exposure testing. Examples of the compatible and non-highly chemical resistant materials include (but are not limited to) ethylene propylene diene monomer rubber (EPDM), polychloroprene (neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (santoprene). Certain non-highly chemical resistant materials such as 316 stainless steel, 6061 aluminum, and polysiloxane rubber (silicone) may not have desired compatibility with the redox flow batteries in accordance with several embodiments.

In many embodiments, the batteries can be redox flow batteries. In some embodiments, the redox flow batteries have a capacity retention of greater than 99% over a period of at least two weeks. In some embodiments, the redox flow batteries have a capacity retention of greater than 99.9% over a period of at least two weeks.

In certain embodiments, the components of the flow batteries can be made using various processes including (but not limited to) melt-processes, thermoforming processes, additive manufacturing processes, 3D printing processes, and any combinations thereof. Examples of thermoforming processes include (but are not limited to) injection molding, blow forming, and extrusion. In several embodiments, the components can be made of materials comprising hydrocarbon plastics, elastomers, and/or rubbers including (but not limited to) polyethylene, polypropylene, polycarbonate, polystyrene, polyoxymethylene, santoprene, EPDM, neoprene, PEEK, POM, PVC, PMMA, polyurethane, nylon, sodium besylate, sodium tosylate, propylene carbonate, sulfolane, BUNA-N, natural latex rubber, latex, natural gum rubber, and any combinations thereof.

In many embodiments, the reaction vessel (also known as flow frame) defining the half-cell interiors of the battery can be made of at least one non-fluorinated polymer. Examples of non-fluorinated polymers include (but are not limited to) polyethylene, polypropylene, polymethylpentene (PMP), polybutene-1, PVC, polystyrene, PMMA, acrylonitrile butadiene styrene (ABS), nylon, POM, polycarbonate, PEEK, and any combinations thereof. In some embodiments, the reaction vessel can be made of copolymers derived from two or more of the aforementioned polymers.

The bipolar plates in the half cells that are in contact with the catholyte or the anolyte solution can be made of graphite or a polymer composite. In some embodiments, the bipolar plate can be made of resin-filled graphite composite. In certain embodiments, the polymer of the resin-filled graphite composite can be polyethylene or polypropylene. In some embodiments, the resin-filled graphite composite can be a thermoset resin including (but not limited to) phenolic resins.

In several embodiments, the gaskets in the half cells that are in contact with the catholyte or the anolyte solution can be made of a non-fluorinated elastomeric material. In some embodiments, the non-fluorinated elastomeric material is a non-highly chemical-resistant rubber material including (but not limited to) EPDM, santoprene, neoprene, butadiene-styrene (BUNA-S), BUNA-N, latex, trans-isoprene, silicone, or polyurethane.

In many embodiments, the redox flow battery can include supply lines and/or tubing positioned outside of the half cells carrying the anolyte solution and catholyte solution into the first and second half-cell, respectively. The supply lines in accordance with several embodiments can be made of materials that are not designated as highly chemically resistant. In certain embodiments, the supply lines can be made of non-fluorinated elastomeric polymers. In various embodiments, the supply lines can be made of non-highly chemical-resistant rubber materials including (but not limited to) EPDM, santoprene, neoprene, BUNA-S, BUNA-N, latex, trans-isoprene, silicone, or polyurethane. In a number of embodiments, the supply lines can be made of hard plastics including (but not limited to) polyethylene, polypropylene, or polyvinyl chloride.

In some embodiments, the membranes of the redox flow batteries can be made of ion exchange membranes including (but not limited to) anion exchange membranes. Several embodiments use Selemion™ anion or cation exchange membranes and/or Selemion™ AMVN and/or Selemion™ CMVN membranes in the redox flow batteries. Selemion™ AMVN is a polystyrene-based anion exchange membrane and may contain various functional groups. Selemion™ CMVN is a polystyrene-based cation exchange membrane and may contain various functional groups Certain embodiments use Fumasep™ FAA-3-20 as anion exchange membranes in the redox flow batteries. Certain embodiments use Fumasep™ FAA-3-50 as anion exchange membranes in the redox flow batteries. Certain embodiments use Fumasep™ FAS-30 as anion exchange membranes in the redox flow batteries. Certain embodiments use Fumasep™ FAM-PP as anion exchange membranes in the redox flow batteries. Certain embodiments use Fumasep™ FAPQ-375-PP as anion exchange membranes in the redox flow batteries. Certain embodiments use Fumasep™ FKS-PK-75 as cation exchange membranes in the redox flow batteries. Certain embodiments use Fumasep™ FKS-50 as cation exchange membranes in the redox flow batteries. Certain embodiments use Fumasep™ E620K as cation exchange membranes in the redox flow batteries. Fumasep™ FAA-3-30, FAA-3-50, FAS-30, FAM-PP, and FAPQ-375-PP are anion exchange membranes. Fumasep™ FKS-PK-75, FKS-50, and E620K are anion exchange membranes. Fumasep™ membranes are polyether ether ketone-based membranes and may contain various functional groups.

Many embodiments provide that the redox flow batteries are compatible with functional groups such as small molecules including (but not limited to) sodium besylate, sodium tosylate, propylene carbonate, sulfolane, and any combinations thereof.

Some embodiments include a compound of Formula (I):

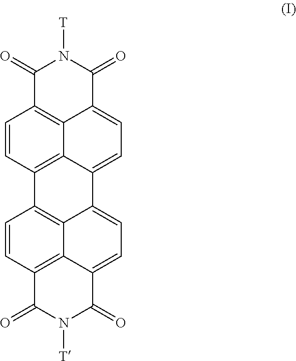

or a salt thereof, wherein:
T is -(L-G)ₙ-X;
T′ is H, (C₁-C₆)alkyl, or -(L-G)ₙ-X;
L is —(C₂-C₅)-alkyl optionally substituted with OH, OCH₃, halo

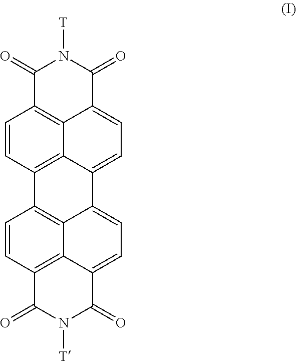

each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20.

In some embodiments, T and T′ are each independently -(L-G)ₙ-X.

In some embodiments, wherein L is unsubstituted —(C₂-C₅)-alkyl.

In some embodiments, L is ethyl or propyl.

In some embodiments, n is 2, 3, or 4.

In some embodiments, G is

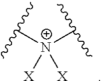

In some embodiments, wherein X is H, methyl or —CH₂CH₂OH.

In some embodiments, each X is independently H or —(C₁-C₆)-alkyl.

In some embodiments, at least one X is —CH₃CH₂OH.

In some embodiments, the compound of Formula (I) is:

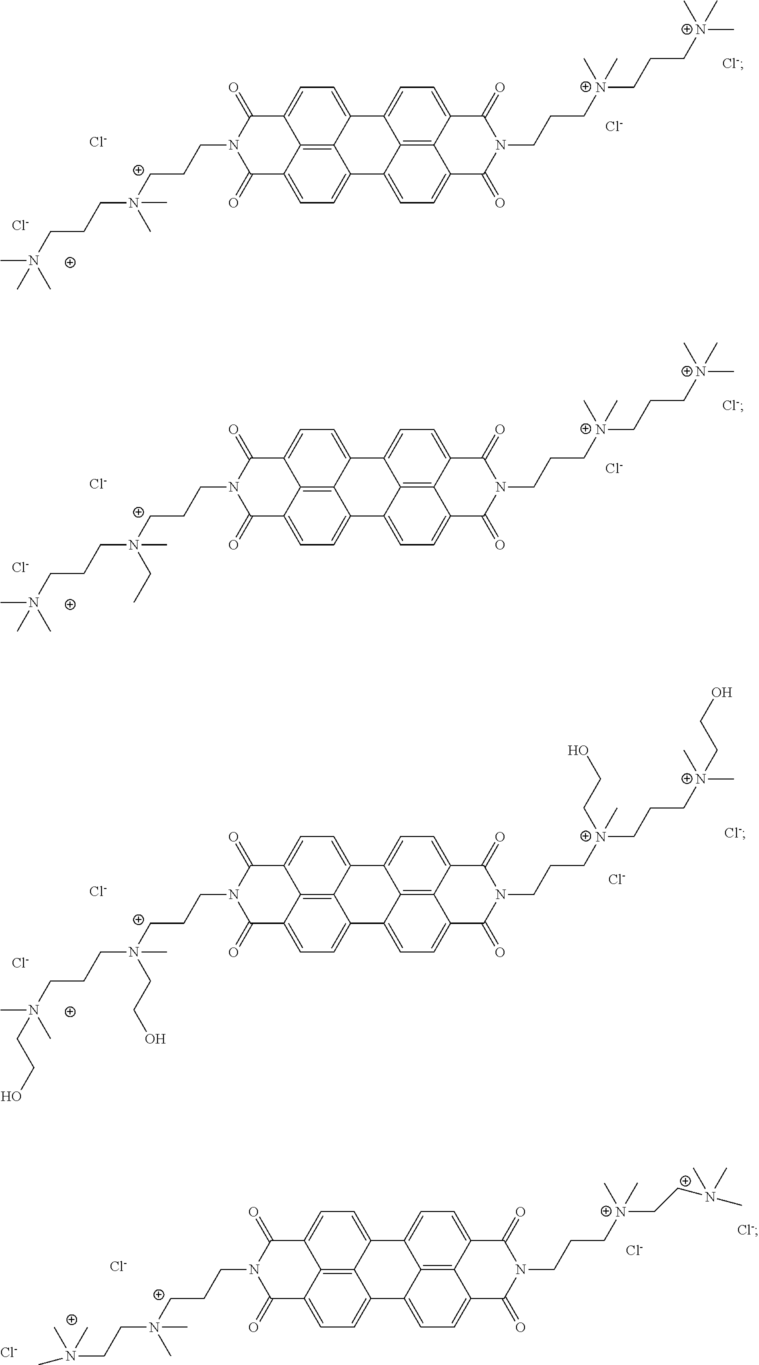

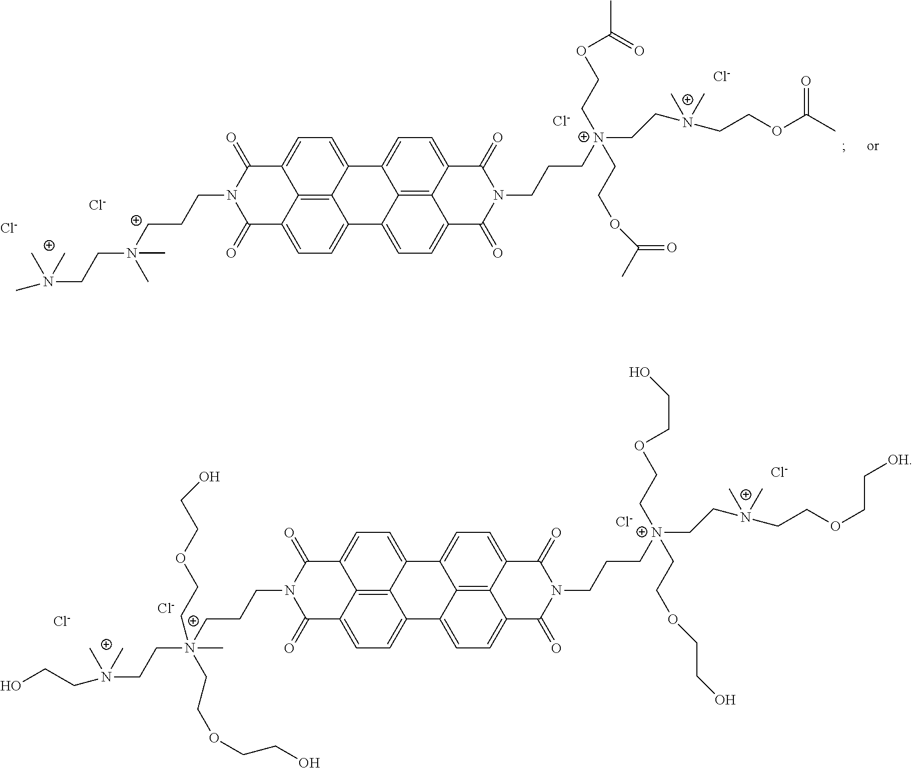

Some embodiments include a compound of Formula (II):

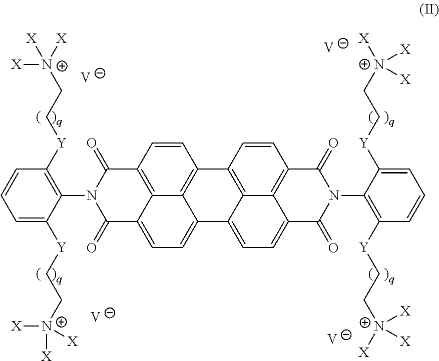

wherein
each Y is independently —O—, —S— or —NH—;
each q is independently 1 to 8; and
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂; and each V is a counterion.

In some embodiments, the compound of Formula (II) is:

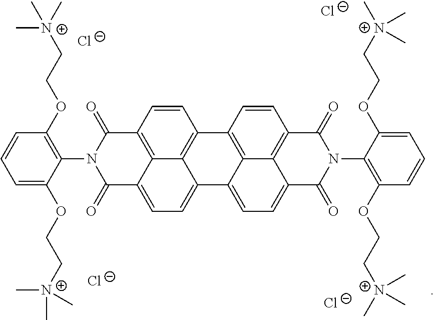 [SMILES: C[N+](C)(C)CCOc1cccc(OCC[N+](C)(C)C)c1N1C(=O)c2ccc3c4ccc5c6c(ccc(c7ccc(c2c37)C1=O)c64)C(=O)N(c1c(OCC[N+](C)(C)C)cccc1OCC[N+](C)(C)C)C5=O ; [Cl-] ; [Cl-] ; [Cl-] ; [Cl-]]

Some embodiments include a compound of Formula (III):

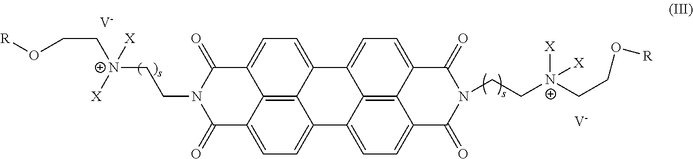

wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-6)alkyl; and
each V⁻ is a counterion.

In some embodiments, the compound of Formula (III) is:

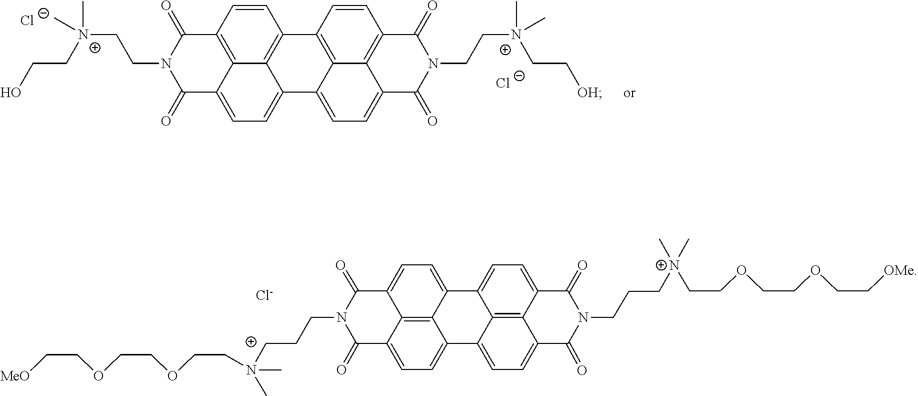

Some embodiments include a compound of Formula (IV):

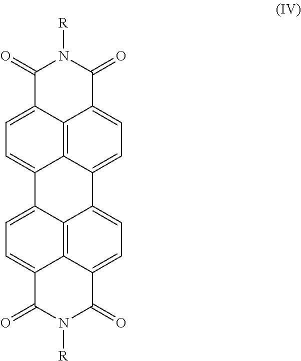

wherein
R is

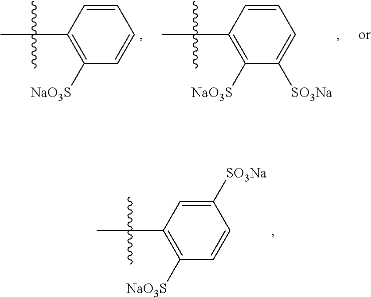

In some embodiments, the compound of Formula (IV) is

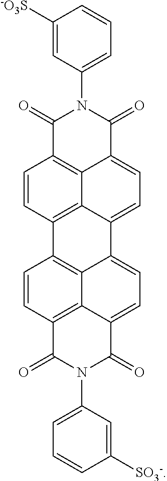

Some embodiments include a compound of Formula (V):

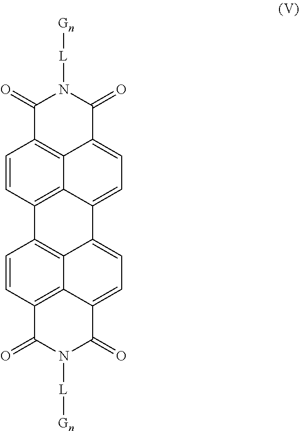

or a salt thereof, wherein
L is —(C₁-C₆)-alkyl;
each G is

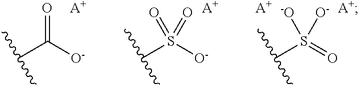

A is a cation; and
n=1 to 5.

In some embodiments, L is substituted with OH, OCH₃, and halo.

In some embodiments, each A is lithium, sodium, potassium, or ammonium.

In some embodiments, each G is

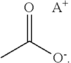

In some embodiments, each L is propyl.

In some embodiments, n is 2.

In some embodiments, L-Gₙ group has at least one chiral center.

In some embodiments, the formula (V) has at least one stereoisomer.

In some embodiments, the compound of Formula (V) is

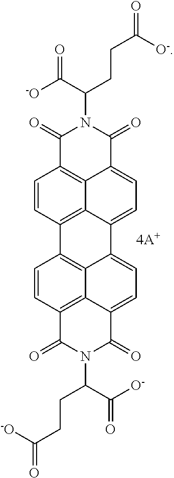

In some embodiments, the compound of Formula (V) is

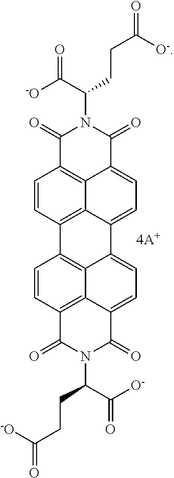

In some embodiments, the compound of Formula (V) is

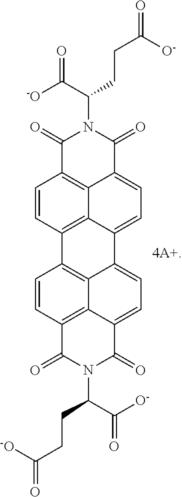

In some embodiments, the compound of Formula (V) is selected from the group consisting of:

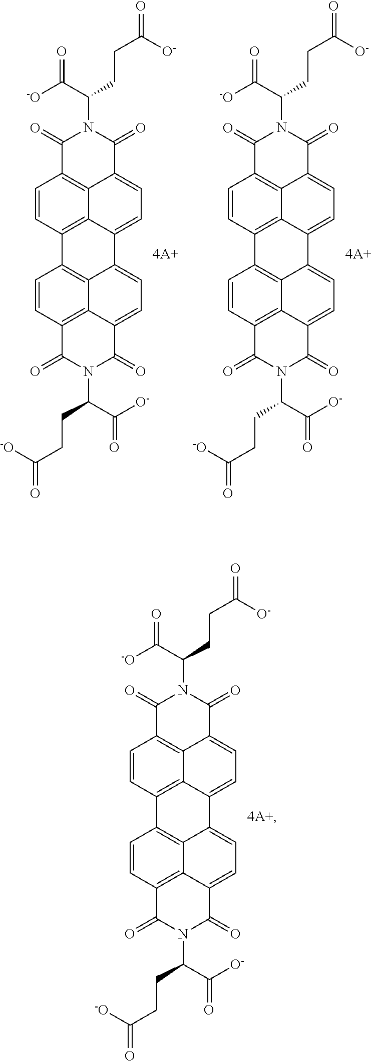

and any combinations thereof.

In some embodiments, A is lithium, sodium, potassium, or ammonium.

In some embodiments, the compound of Formula (V) is

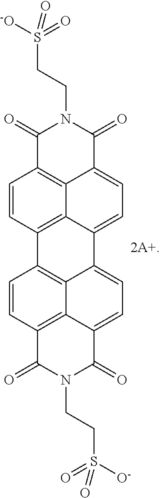

Some embodiments include a compound has a formula selected from the group consisting of:

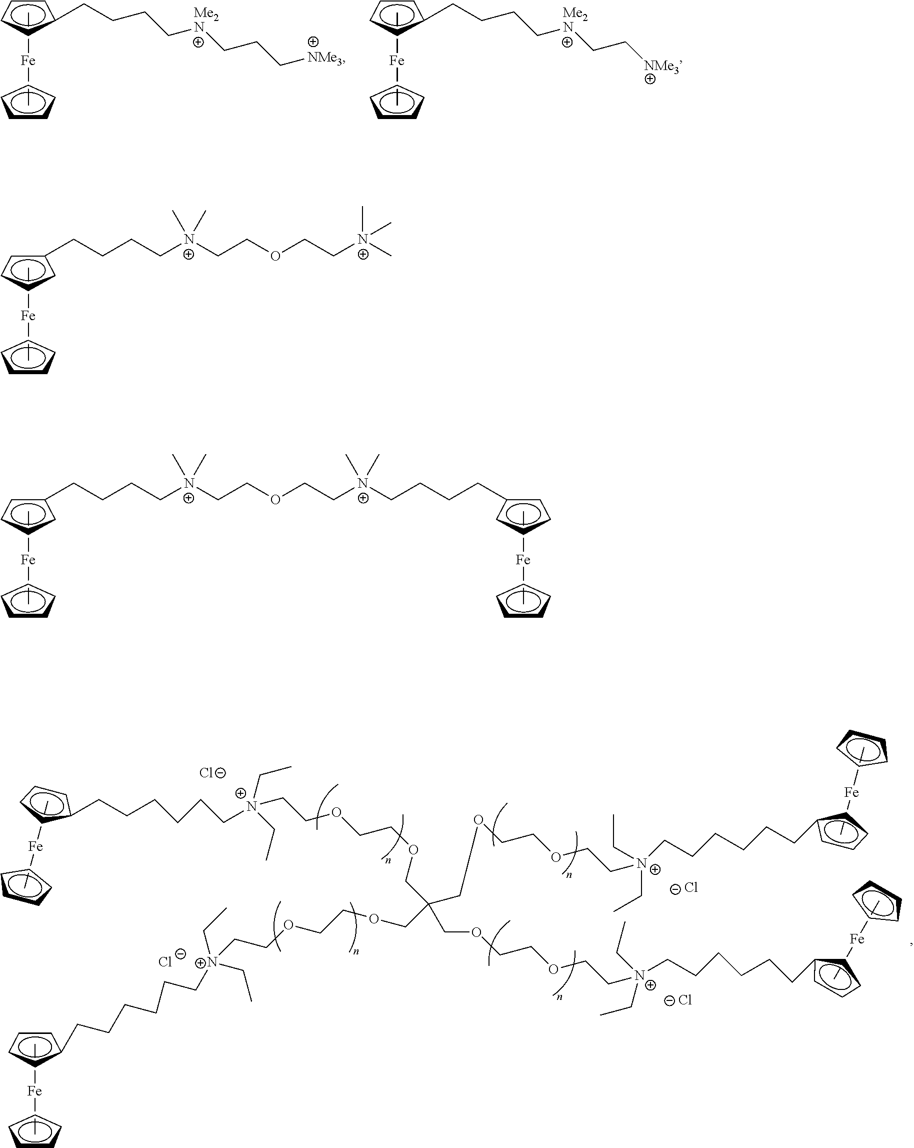

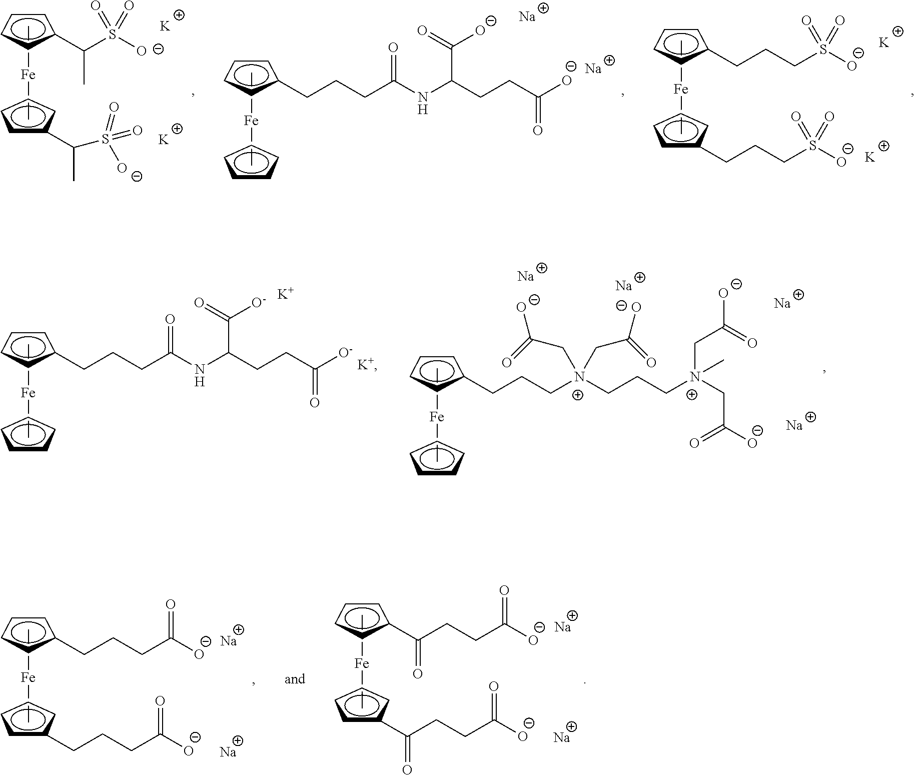

Some embodiments include a compound of Formula (VI):

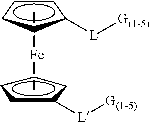

wherein:
L is —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;

L′ is —H, —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
G is selected from the group consisting of

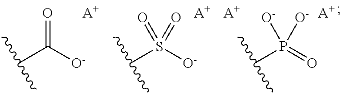

G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl.

In some embodiments, L is substituted by at least one group selected from the group consisting of: G, —OH, —OCH₃, and -halo.

In some embodiments, L′ is substituted at least one group selected from the group consisting of: G, —OH, —OCH₃, and -halo.

In some embodiments, R² is substituted by at least one G.

In some embodiments, L-Gₙ has at least one chiral center.

In some embodiments, the compound has at least one stereoisomer.

In some embodiments, the compound of Formula (VI) is

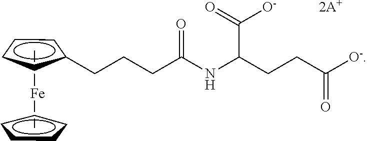

In some embodiments, the compound of Formula (VI) is

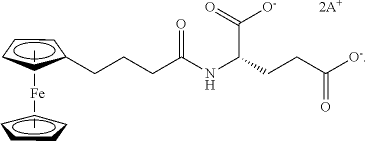

In some embodiments, the compound of Formula (VI) is

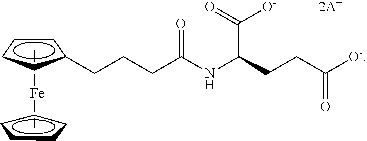

In some embodiments, the compound of Formula (VI) is selected from the group consisting of:

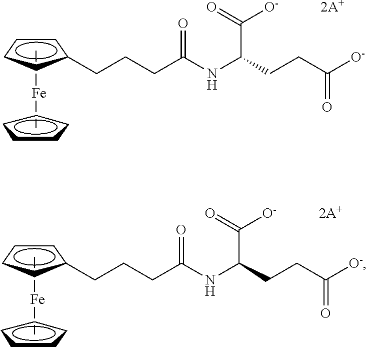

and any combination thereof.

In some embodiments, the compound of Formula (VI) is

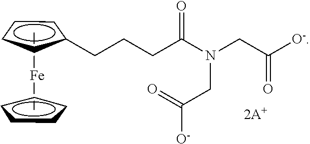

Some embodiments include a redox flow battery comprising: a first half-cell containing a first aqueous solution comprising a first electrode and an anolyte; wherein the anolyte comprises a perylene diimide compound; a second half-cell containing a second electrode and a second aqueous solution comprising a catholyte; and a separator interposed between the first half-cell and the second half cell; wherein the interior surfaces of the first half-cell that contacts the first aqueous solution and the second half-cell that contacts second aqueous solution comprise one or more non-highly chemical-resistant materials.

In some embodiments, the non-highly chemical-resistant material is a polymer.

In some embodiments, the polymer is a non-fluorinated polymer.

In some embodiments, the non-fluorinated polymer is selected from the group consisting of: a polyolefin, a polyether, a polyketone, a polyamide, a polyurea, a natural rubber, and a combination thereof.

In some embodiments, the non-fluorinated polymer is a copolymer of two or more polymers selected from the group consisting of: a polyolefin, a polyether, a polyketone, a polyamide, a polyurea, and a natural rubber.

In some embodiments, the non-fluorinated polymer is selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (Santoprene), and a combination thereof.

In some embodiments, the non-fluorinated polymer is a copolymer of two or more polymers selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), and EPDM polypropylene matrix elastomer (Santoprene).

In some embodiments, the first half-cell comprises a first bipolar plate and the second half-cell comprises a second bipolar plate, wherein the first bipolar plate comprises a composite material of graphite and a polymer.

In some embodiments, the composite material is resin-filled graphite.

In some embodiments, the first bipolar plate material comprises graphite in a thermoset resin matrix.

In some embodiments, the polymer of the composite material is polyethylene or polypropylene.

Some embodiments further comprise a gasket separating the reaction vessel from the first bipolar plate, wherein the gasket comprises a non-highly chemical-resistant elastomeric material.

In some embodiments, the non-highly chemical-resistant elastomeric material is a non-fluorinated elastomeric material.

In some embodiments, the non-highly chemical-resistant elastomeric material is selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (Santoprene), and a combination thereof.

In some embodiments, the separator comprises an ion-exchange membrane.

In some embodiments, the ion-exchange membrane comprises a non-fluorinated polymer.

In some embodiments, wherein the ion-exchange membrane is a polystyrene-based ion-exchange membrane.

Some embodiments further comprise a supply line positioned outside the first half cell to supply the anolyte to the first half cell, wherein the supply line comprises a non-highly chemical-resistant elastomeric material.

In some embodiments, the non-highly chemical-resistant elastomeric material is a non-fluorinated elastomeric polymer.

In some embodiments, the non-highly chemical-resistant elastomeric material is selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (Santoprene), and a combination thereof.

In some embodiments, the perylene diimide compound has a Formula (I):

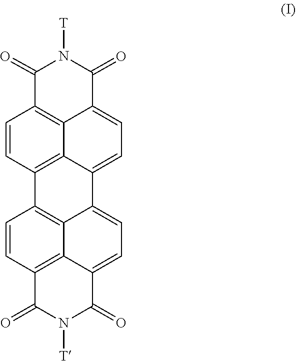

or a salt thereof, wherein:
T is -(L-G)ₙ-X;
T′ is H, (C₁-C₆)alkyl, or -(L-G)ₙ-X;
L is —(C₂-C₅)-alkyl optionally substituted with OH, OCH₃, halo

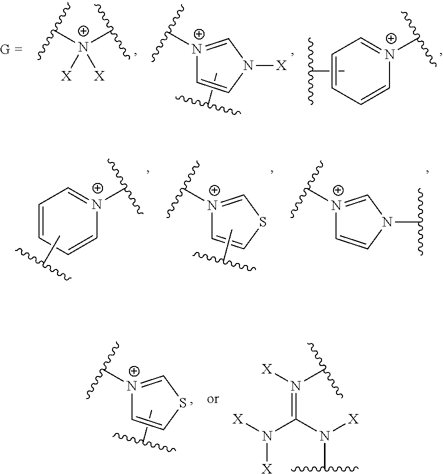

each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20;

In some embodiments, the perylene diimide compound has a Formula (II):

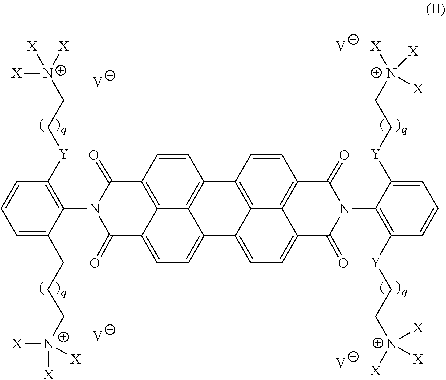

wherein
each Y is independently —O—, —S— or —NH—;
each q is independently 1 to 8; and
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂; and each V is a counterion.

In some embodiments, the perylene diimide compound has a Formula (III):

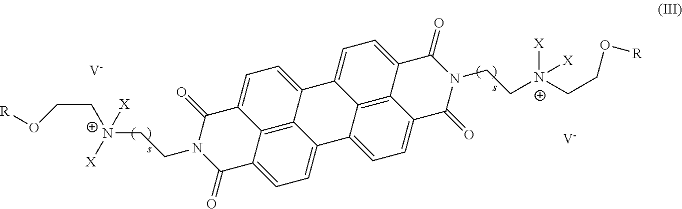

wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-6)alkyl; and each V⁻ is a counterion.

In some embodiments, the perylene diimide compound has a Formula (IV):

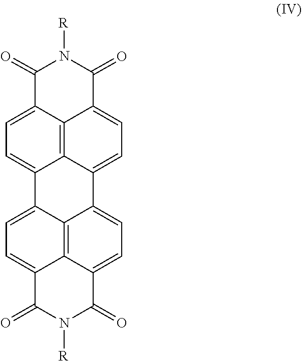

wherein
R is

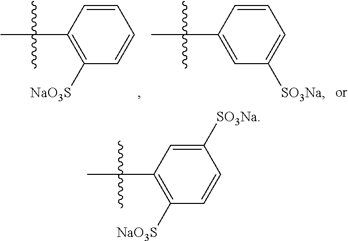

In some embodiments, the perylene diimide compound has a Formula (V):

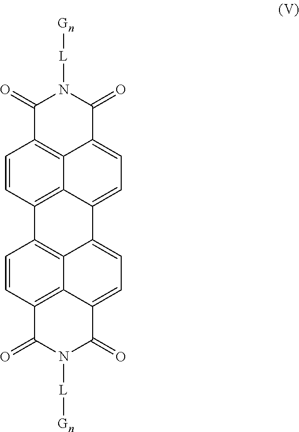

or a salt thereof, wherein
L is —(C₁-C₆)-alkyl;
each G is

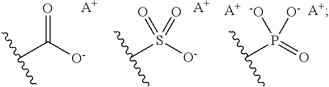

A is a cation; and
n=1 to 5.

In some embodiments, the catholyte comprises a ferrocene compound.

In some embodiments, the ferrocene compound has a formula selected from the group consisting of:

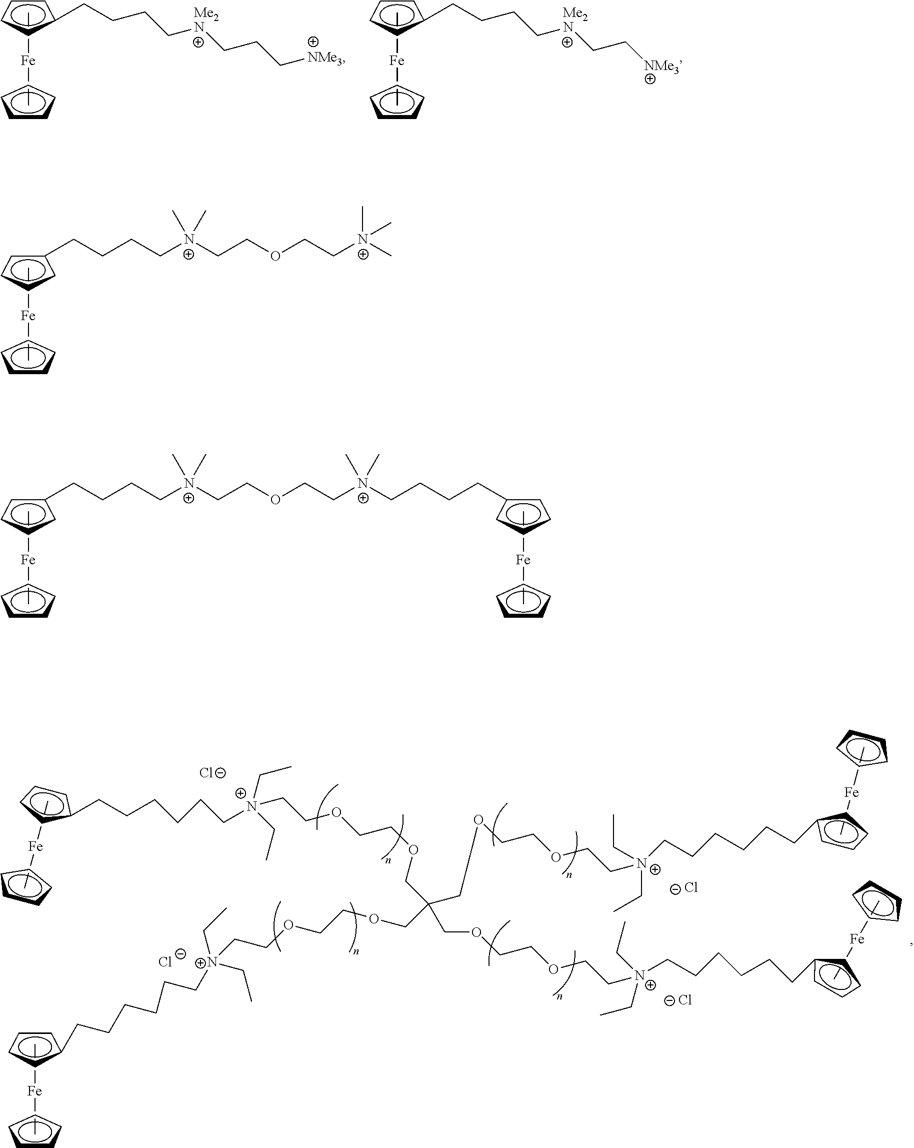

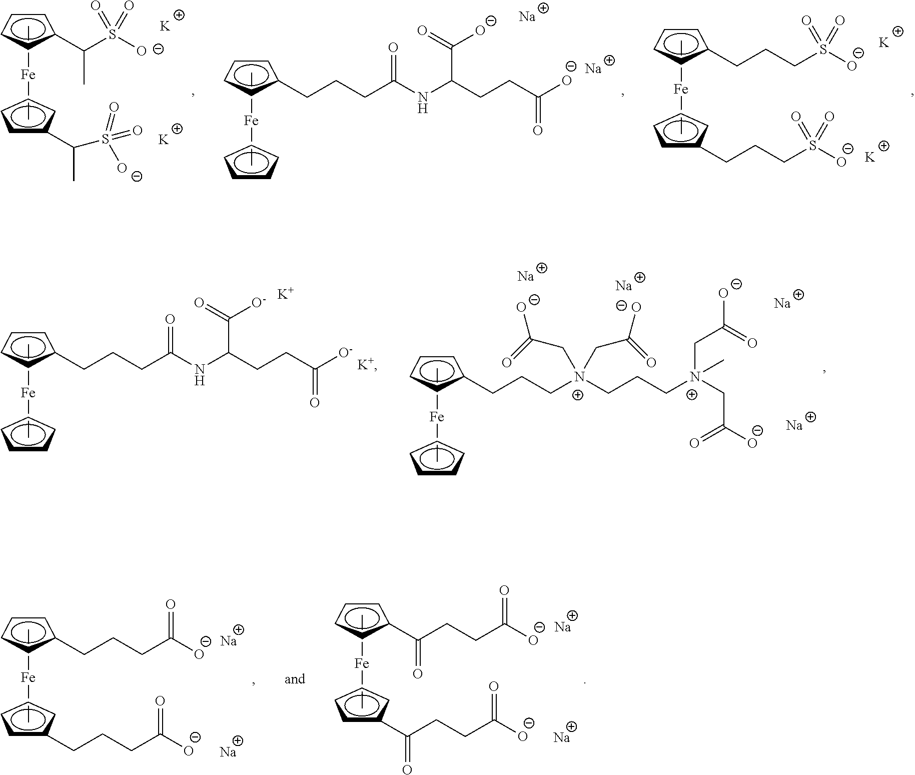

In some embodiments, wherein the ferrocene compound has a formula (VI):

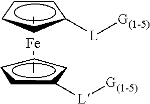

wherein:
L is —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
L′ is —H, —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
G is selected from the group consisting of

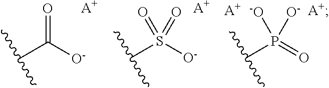

G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF FIGURES

The description will be more fully understood with reference to the following figures, which are presented as example embodiments of the invention and should not be construed as a complete recitation of the scope of the invention, wherein:

FIG. 1 illustrates a redox flow battery with components made with low-cost materials in accordance with an embodiment of the invention.

FIG. 2 illustrates a prototype of a redox flow battery in accordance with an embodiment of the invention.

FIGS. 3A and 3B illustrate H-cell components and an assembled H-cell in accordance with an embodiment of the invention.

FIG. 4A illustrates the capacity of a H-cell cycling test with nylon in accordance with an embodiment of the invention.

FIG. 4B illustrates the capacity of a H-cell cycling test with 316 stainless steel in accordance with an embodiment of the invention.

FIG. 5 illustrates a schematic of H-cell cycling process in accordance with an embodiment of the invention.

FIGS. 6A through 6C illustrate HPLC results for EPDM in high-state of charge exposure tests in accordance with an embodiment of the invention.

FIG. 7 illustrates coulombic efficiency of a 10 mAh flow cell in accordance with an embodiment of the invention.

FIG. 8A illustrates capacity retention of a redox flow battery fabricated with a polypropylene flow frame in contact with the electrolyte solutions after 14 days of cycling in accordance with an embodiment of the invention.

FIG. 8B illustrates Coulombic efficiency of a redox flow battery fabricated with a polypropylene flow frame in contact with the electrolyte solutions after 14 days of cycling in accordance with an embodiment of the invention.

FIG. 9 illustrates cycling of glutamic-PDI and bis-propylsulfonate ferrocene in accordance with an embodiment of the invention.

FIG. 10 illustrates cycling of glutamic-PDI and glutamic-amide ferrocene in accordance with an embodiment of the invention.

### DETAILED DESCRIPTION

Turning now to the drawings, redox flow batteries comprising low-cost and non-highly chemical resistant components and mild electrolytes are described.

Vanadium redox flow batteries are a robust system due to the long-lifetime of the electrolytes. However, high system costs have prevented their commercialization and adoption. These costs stem largely from the cell components due to the extremely corrosive nature of the vanadium formulation. Conventional vanadium redox flow batteries include a highly oxidizing electrolyte of V²⁺/V³⁺ and VO²⁺/VO²⁺ ions dissolved in a solution of sulfuric acid (H⁺, HSO₄, SO₄²− ions) at pH less than 1. The highly acidic and corrosive environment of vanadium redox flow batteries necessitate fluorination of polymer backbone for a high chemical resistance as a result of the higher binding energy of a C—F bond compared to a C—H bond. The fluorinated materials can be very expensive in device components, due to complex synthesis leading to a high material cost, as well as difficult manufacturing. For example, polytetrafluroethylene (PTFE), also known as Teflon, requires special processing techniques and is shaped into parts via compression molding and machining since the polymer cannot melt or flow.

Conventional vanadium redox flow batteries may need fluorinated elastomers such as PTFE as soft materials, isomolded graphite as bipolar plates, fluorinated Nafion membranes as ion exchange membranes, and fluorinated rubber for cell fabrication. This fabrication is generally difficult and time consuming due to the poor manufacturing properties of these materials, such as a lack of melting point to enable injection molding or thermal forming. Replacement of these highly chemically resistant materials with less expensive and easily manufacturable plastics and rubbers would greatly improve the ability to high throughput manufacture these cells to take full advantage of the scalable architecture of separating power and energy. An attempt to replace the pyrolytic, highly resistant, graphite bipolar plates in vanadium systems with plastic filled composites showed rapid degradation of the part and poor battery performance. (See, e.g., Liu, H.; et al., Corrosion behavior of a bipolar plate of carbon-polyethylene composite in a vanadium redox flow battery. RSC Advances 2015, 5 (8), 5928-5932; the disclosure of which is herein incorporated by reference.)

Organic molecules employed as charge-carriers can enable a range of organic solvents and/or aqueous solutions at a non-corrosive range of near-neutral pH levels. However, organic redox flow batteries have not shown long term molecular stability due to the highly unstable nature of organic radicals, which are the species generated upon charge storage in an organic molecule. The unstable nature of the majority of organic radicals is born out in the short temporal lifetime of organic redox flow batteries resulting from a chemical event that consumes, quenches, or degrades the active material in an electrolyte. The chemical event includes (but is not limited to) the reaction of neutral or active charge-carrying species with the materials used in the construction of the device itself. Additionally, the degradation of the cell fabrication materials by contact with the electrolyte formulation can also lead to reduced lifetimes as the mechanical and chemical properties of the materials are changed, resulting in brittleness, leakage, or other unsatisfactory performances. The radical species generated in organic redox flow batteries can be highly reactive radical reductants and oxidants and can react with many functional groups that are present in less expensive and less chemical resistant materials that may include olefins, esters, C—H bonds, and/or amides. Conventional vanadium redox flow batteries are assembled from: 1) highly chemically resistant materials such as (but not limited to) fluorinated polymers, PTFE (Teflon), PVDF (Viton), Nafion, Kalrez and others; 2) non-reactive minerals such as (but not limited to) glass, graphite, and carbon felt; 3) other resistant materials and any coatings to increase chemical resistance; and 4) chemically resistant separators such as fluorinated membranes.

Many embodiments provide electrolyte formulations comprising stable radicals for redox flow batteries. The stable radicals from the electrolyte formulations in accordance with several embodiments may not oxidize or reduce the cell fabrication materials. In some embodiments, the electrolyte formulations can dissolve in aqueous solutions with neutral pH (pH ranging from about 5.5 to about 8.5) that would allow the use of less expensive plastics and natural and synthetic rubbers which can be readily melted, injection molded, and processed on high-throughput equipment. Several embodiments can reduce the cost of cell manufacturing by eliminating corrosive solvents and reactive radical species. Plastics such as polyolefins like polypropylene and polyethylene can be synthesized from natural gas and petroleum. Many embodiments can decrease the costs of the redox flow batteries by lowering the manufacturing and raw material costs using non-highly chemical-resistant materials for various components of the battery systems.

Many embodiments provide redox flow batteries of long-duration and/or long-lifetime for energy storage applications. In some embodiments, water soluble perylene diimide molecules or perylene diimide-based molecules can be used as energy storage materials. In operation, in an anode chamber, molecules containing neutral perylene diimide cores are reduced during charging to store energy, and the reduced form can then be oxidized during discharge to release energy. Respectively in a cathode chamber, electrons can be released from a charge storage material in an oxidation process during charging to store energy, and the charge storage material can then be reduced during discharging to release energy. Several embodiments implement ferrocene or ferrocene-based molecules as the cathode charge storage material. In many embodiments, the perylene diimide molecules, the perylene diimide-based molecules, the ferrocene molecules, and the ferrocene-based molecules, can be compatible with polymeric materials that are inexpensive and easy to process, hence allowing for redox flow batteries of reduced manufacturing costs.

The anolyte solutions in accordance with many embodiments can include water soluble perylene diimide (PDI) molecules. The highly conjugated, electron-poor core of PDI is readily and reversibly reduced to accept two electrons. In several embodiments, perylene diimides with functionality at one or both of the imide nitrogen atoms can be synthesized from perylene tetracarboxylicdianhydride (PD/1) by condensation with primary amines. Organic, water-soluble, polymeric and liquid crystal perylene diimides have been developed, in which the choice of functional groups on one or both nitrogen atoms are covalently bound to groups that can modify the perylene diimide properties. The inventors have discovered that, although these molecular modifications can modify certain perylene diimide properties, these modifications do not significantly impact the charge storage stability of the perylene diimides. Electron and frontier molecular orbital densities for the perylene diimide core are concentrated in the aromatic backbone, meaning that the redox properties of the N-functionalized perylene diimides can be identical in energy level, reversibility, and stability in solution regardless of the modifications. As a result, such molecular modifications do not influence charge storage stability.

In several embodiments, the perylene diimide molecules used as anolytes can include a perylene diimide redox core that is covalently bonded to a solubilizing group. In certain embodiments, the perylene diimide core can be solubilized through attachment of an ionic scaffold. Any common ionic group may be used to solubilize the perylene diimide core including (but not limited to) ammonium ions, carboxylates, phosphonates, sulfonates, imidizoliums, pyridiniums, and thiazoliums. In various embodiments, one or both nitrogen atoms of the perylene diimide core can be covalently bonded to a quaternized aminoalkyl group. In some embodiments, one or both nitrogen atoms of the perylene diimide core can be covalently bonded to carboxylate groups.

In many embodiments, the perylene diimide molecules can be highly stable in their charged and/or uncharged states. The perylene diimide in accordance with several embodiments exhibits stability in their 2-electron reduced states when present in high concentrations in the aqueous media. In some embodiments, the perylene diimide molecules are compatible with both ion-exchange and size exclusion membranes.

Many embodiments provide that the perylene diimide molecules are water soluble. In certain embodiments, the anolyte solutions can include perylene diimide compounds dissolved in water without additional solvents. The perylene diimide compounds can be dissolved in (but not limited to) water, tap water, ground water, well water, filtered water, or deionized water. As can readily be appreciated, any of a variety of water source can be utilized as appropriate to the requirements of specific applications in accordance with various embodiments of the invention. Filtration processes can be carried out to filter any undesired components prior to use. As can be readily appreciated, any of a variety of filtered water and/or any of a variety of a water filtration process can be utilized as appropriate to the requirements of specific applications in accordance with various embodiments of the invention. In some embodiments, the anolyte solutions can include supporting electrolytes including (but not limited to) NaCl, KCl, NH₄Cl, Na₂SO₄, MgCl₂, or a mixture thereof. In certain embodiments, the anolyte solutions may include a co-solvent to increase the solubility of the perylene diimide compounds in the aqueous solution. Examples of co-solvents include (but are not limited to) methanol, propylene carbonate and ethylene glycol.

The perylene diimide molecules in accordance with several embodiments can be chemically stable over a range of pH levels. In some embodiments, the anolyte solutions can be prepared with acidic, neutral or basic aqueous media. In a number of embodiments, the anolyte solutions can be prepared at a neutral pH (pH at about 7) or pH from about 6 to about 8; or pH from about 6.5 to about 7.5. Several embodiments prepare the anolyte solutions in a basic media. In such embodiments, the pH of the anolyte solutions can vary from about 7.5 to about 10. A number of embodiments prepare the anolyte solutions in an acidic media with pH of the anolyte solutions ranging from about 4 to about 6.5; or from about 5 to about 6.5.

In many embodiments, the catholyte solutions can be prepared in an acidic, neutral or basic media. In several embodiments, the catholyte solutions can be prepared at a neutral pH (pH at about 7); or pH from about 6 to about 8; or pH from about 6.5 to about 7.5. Some embodiments prepare the catholyte solutions in a basic media with pH of the catholyte solutions ranging from about 7.5 to about 10. In a number of embodiments, the catholyte solutions can be prepared in an acidic media with pH of the catholyte solutions ranging from about 4 to about 6.5; or from about 5 to about 6.5.

In some embodiments, the pH of both the anolyte and the catholyte solutions can be neutral or close to neutral (pH ranging from about 5.5 to about 8.5). In several embodiments, the anolyte and catholyte solutions can be prepared using tap water.

In various embodiments, the perylene diimide compounds can have the structure of Formula (I):

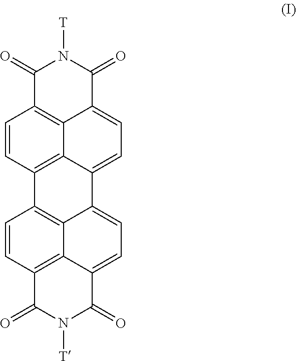

or a salt thereof, wherein:
T is -(L-G)ₙ-X;
T′ is H, C₁-6alkyl, or -(L-G)ₙ-X;
L is —(C₂-C₅)-alkyl optionally substituted with OH, OCH₃, halo;

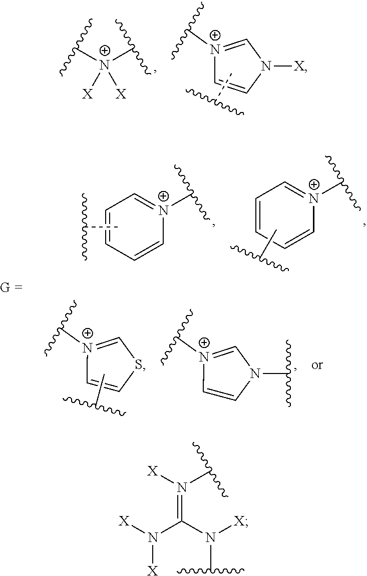

each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20.

In the compound of Formula (I), each L-G group of variable T can be the same or different. In some embodiments, if n equals to 2, each L can be ethyl. In certain embodiments, the first L group may be ethyl, and the second L group may be propyl. The G group of variable T can be the same or different in accordance with some embodiments. In some embodiments, if n equals to 2, each G group of L-G can be an ammonium group. In several embodiments, the first G group may be an ammonium group and the second G group may be a pyridinium group.

In some embodiments, the perylene diimide molecule of Formula (I) where the perylene diimide compounds can be symmetrical (i.e. T=T′). In certain embodiments, the perylene diimide compounds are unsymmetrical (i.e. T and T′ are not equivalent).

In several embodiments, the perylene diimide molecule of Formula (I), each L of L-G is ethyl or propyl.

In some embodiments, the perylene diimide molecule is a compound of Formula (I) where n can be 2. In several embodiments, the perylene diimide molecule is a compound of Formula (I) where n can be 3. In certain embodiments, the perylene diimide molecule is a compound of Formula (I) where n can be 4.

In many embodiments, the perylene diimide molecule of Formula (I) where L can be unsubstituted —(C₂-C₅)-alkyl. In certain embodiments, L can be unsubstituted ethyl. In some embodiments, L can be unsubstituted propyl.

In some embodiments, the perylene diimide molecule of Formula (I) where G can be

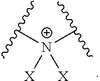

In several embodiments, each X can be H. In various embodiments, each X can be methyl. In certain embodiments, one X can be H and at least one other X can be methyl. In certain embodiments, at least one X can be —CH₂CH₂OH.

In some embodiments, the perylene diimide molecule of Formula (I) where each X can be independently H or —(C₁-C₆)-alkyl.

In a number of embodiments, the perylene diimide molecule of Formula (I) where at least one X can be —(C₁-C₆)-alkyl-OH. In some embodiments, at least one X can be —CH₃CH₂OH.

In many embodiments, the compound of Formula (I) has the following structure:

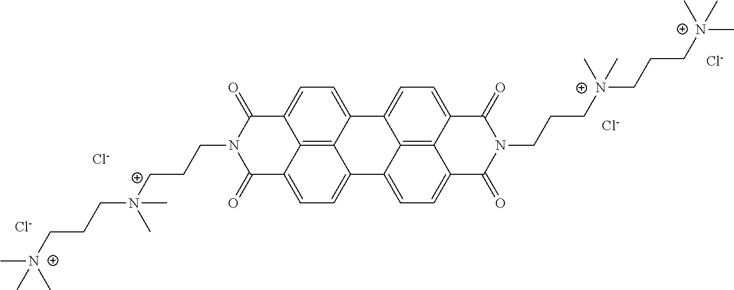

In certain embodiments, the compound of Formula (I) has the following structure:

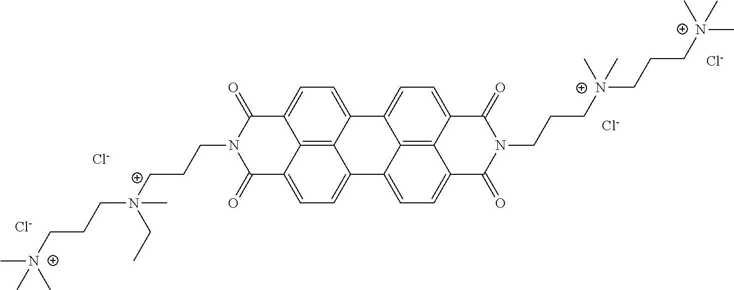

In some embodiments, the compound of Formula (I) has the following structure:

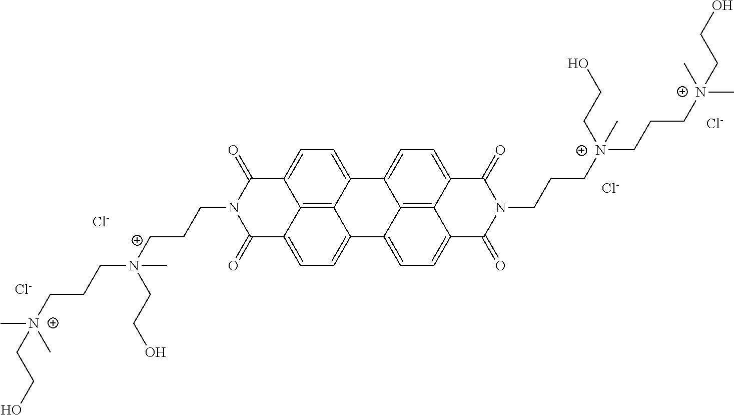

In several embodiments, the compound of Formula (I) has the following structure:

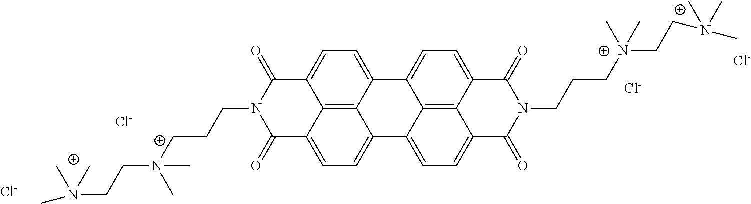

In many embodiments, the compound of Formula (I) has the following structure:

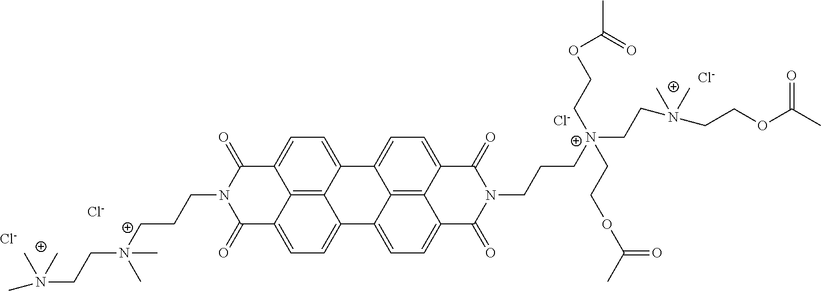

In some embodiments, the compound of Formula (I) has the following structure:

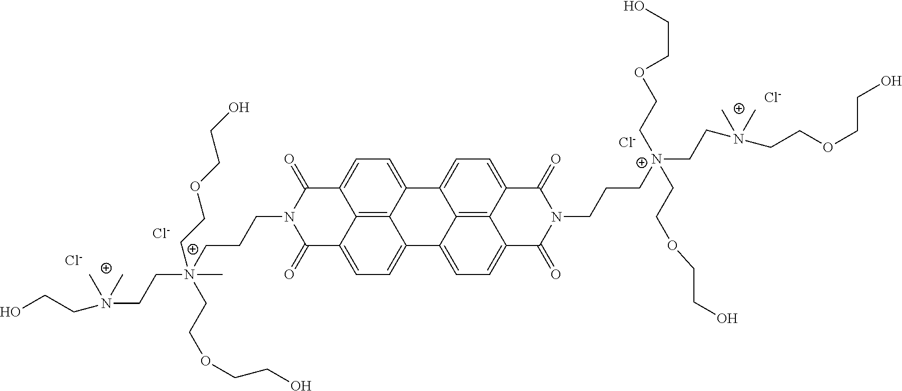

In a number of embodiments, the perylene diimide compounds have the structure of Formula (II):

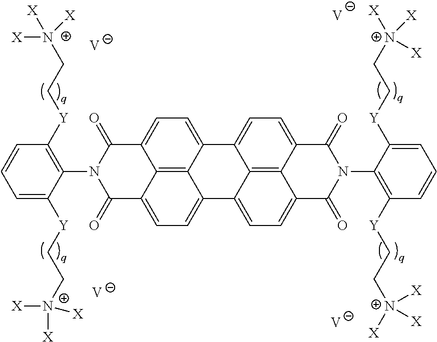

wherein
each Y is independently —O—, —S— or —NH—;
each q is independently 1 to 8;
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂; and
each V is a counterion.

In some embodiments, the compound of Formula (II) has the following structure:

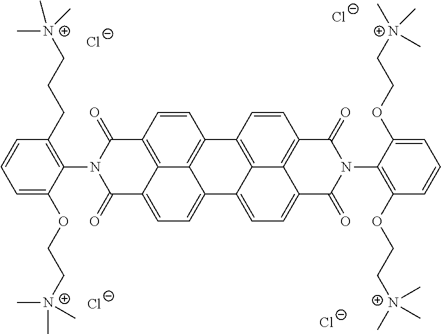 [SMILES: C[N+](C)(C)CCCc1cccc(OCC[N+](C)(C)C)c1N1C(=O)c2ccc3c4ccc5c6c(ccc(c7ccc(c2c37)C1=O)c64)C(=O)N(c1c(OCC[N+](C)(C)C)cccc1OCC[N+](C)(C)C)C5=O ; [Cl-] ; [Cl-] ; [Cl-] ; [Cl-]]

In various embodiments, the perylene diimide compounds have the structure of Formula (III):

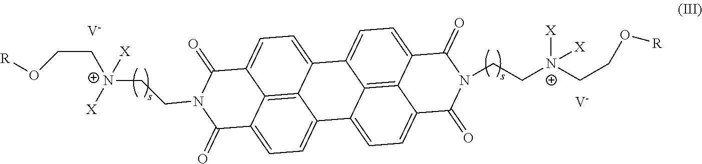

wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-C₆)alkyl; and
each V is a counterion.

In several embodiments, the compound of Formula (III) has the following structure:

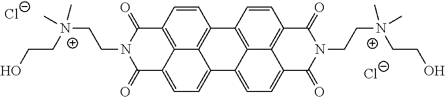 [SMILES: [Cl-] ; C[N+](C)(CCO)CCN1C(=O)c2ccc3c4ccc5c6c(ccc(c7ccc(c2c37)C1=O)c64)C(=O)N(CC[N+](C)(C)CCO)C5=O ; [Cl-]]

In some embodiments, the compound of Formula (III) has the following structure:

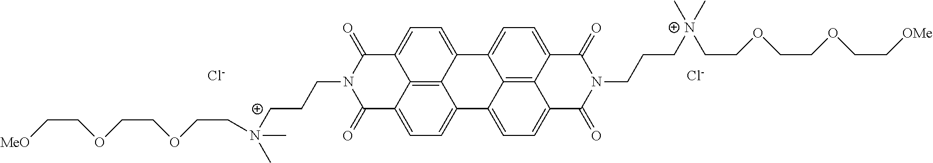

In certain embodiments, the perylene diimide compounds have the structure of Formula (IV):

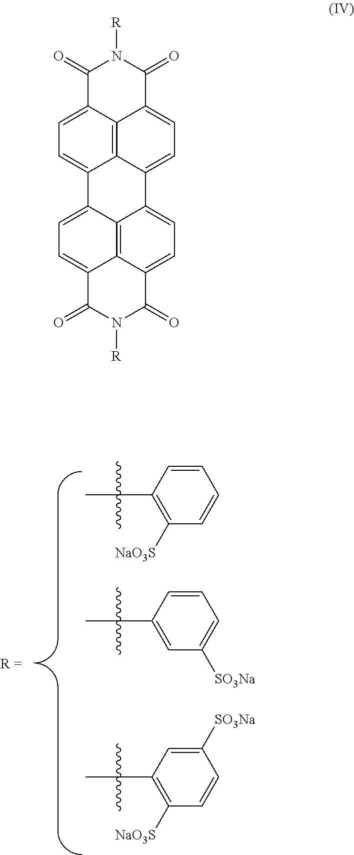

In some embodiments, the compound of Formula (IV) has the following structure:

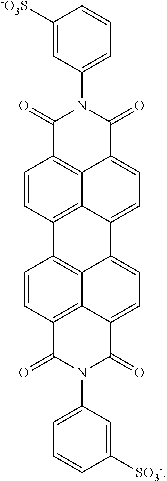

In some embodiments, the perylene diimide compounds have the structure of Formula (V):

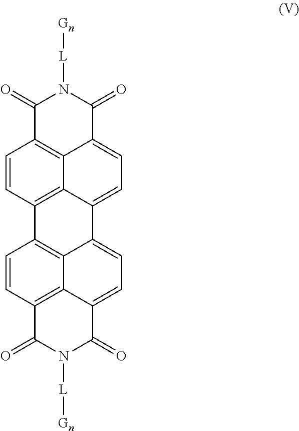

or a salt thereof, wherein:
each L is independently a —(C₁-C₆)-alkyl, optionally substituted with OH, OCH₃ and halo;
each G may be independently selected from

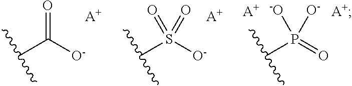

A is a cation; and
n=1 to 5.

In certain embodiments, A can be lithium, sodium, potassium, or ammonium in Formula (V).

In some embodiments, G can be

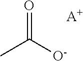

### in Formula (V).

In several embodiments, L can be propyl in Formula (V).

In certain embodiments, n can be 2 in Formula (V).

In certain embodiments, the L-Gₙ group may have one or more chiral centers. If that is the case, the resulting compound of Formula (V) may have several stereoisomers. In some embodiments, the compound may be a single stereoisomer. In other embodiments, the compound may be a mixture of two or more stereoisomers in any ratio. The mixture may comprise every stereoisomer of a compound, or it may exclude one or more. If no chirality is indicated at the stereocenter, then the compound may be comprised of any mixture of stereoisomers.

In many embodiments, the compound of Formula (V) can be:

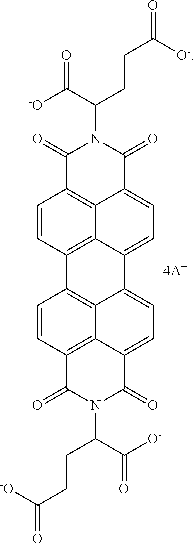

In certain embodiments, the compound of Formula (V) can be:

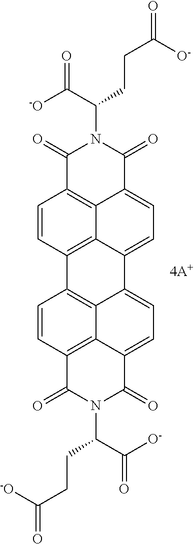

In certain embodiments, the compound of Formula (V) can be:

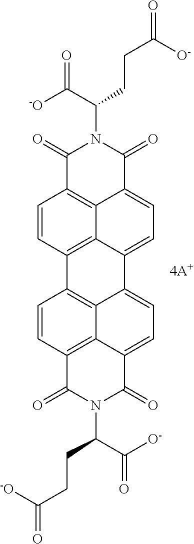

In certain embodiments, the compound of Formula (V) can be any mixture of the following stereoisomers:

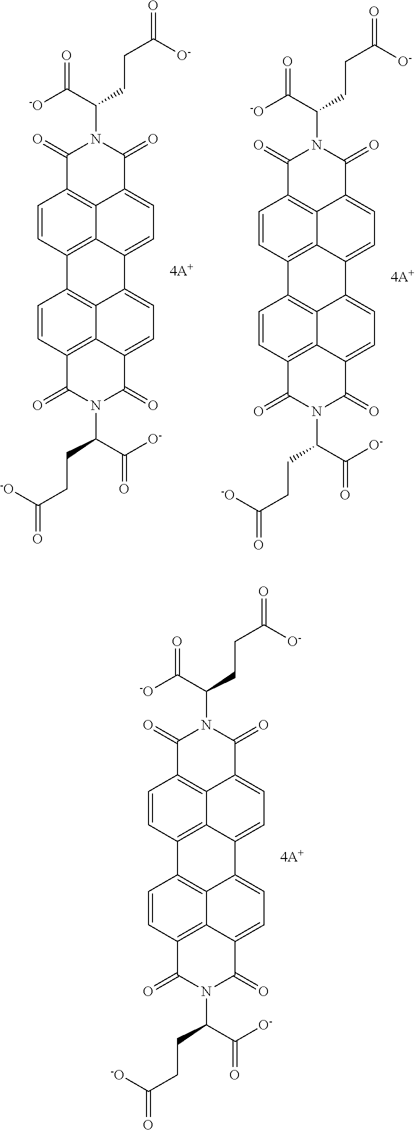

In certain embodiments, the compound of Formula (V) can be:

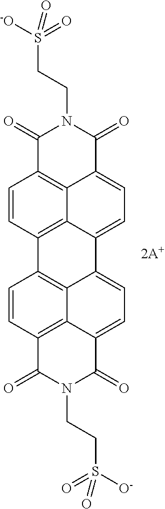

The redox flow batteries in accordance with many embodiments can include a catholyte solution in the cathode chamber. In some embodiments, the catholyte solution comprises a water soluble redox-active organic molecule. In certain embodiments, the redox-active component of the catholyte can include (but are not limited to) TEMPO, ferrocyanide, iodine, or other catholyte materials.

In some embodiments, the redox-active component of the catholyte solution is a water-soluble ferrocene-based compound. In certain embodiments, the ferrocene core can be solubilized through attachment of an ionic scaffold. In several embodiments, the scaffold may contain ammonium ions. In a number of embodiments, the scaffold may contain carboxylate ions. In some embodiments, the scaffold may contain sulfonate ions. Any common ionic group may be used to solubilize the ferrocene core including (but not limited to) carboxylates, phosphonates, sulfonates, imidizoliums, pyridiniums, and thiazoliums.

In various embodiments, the ferrocene-based molecule has one of the following structures:

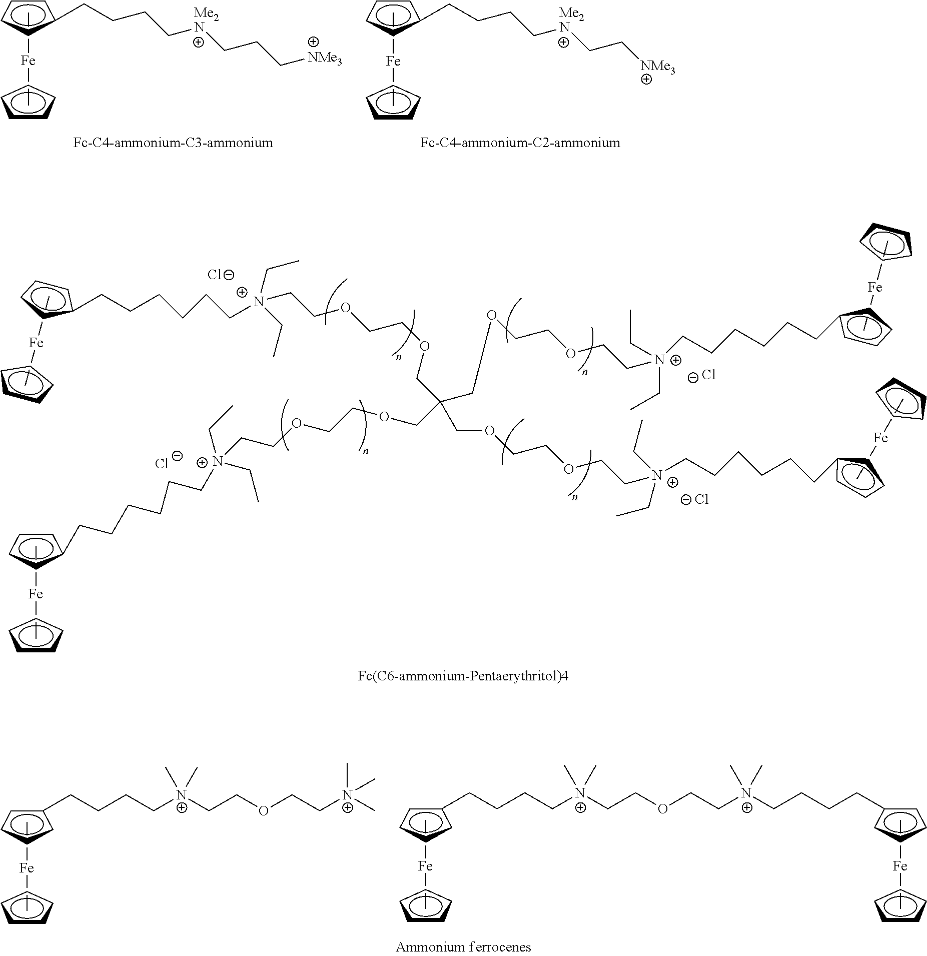

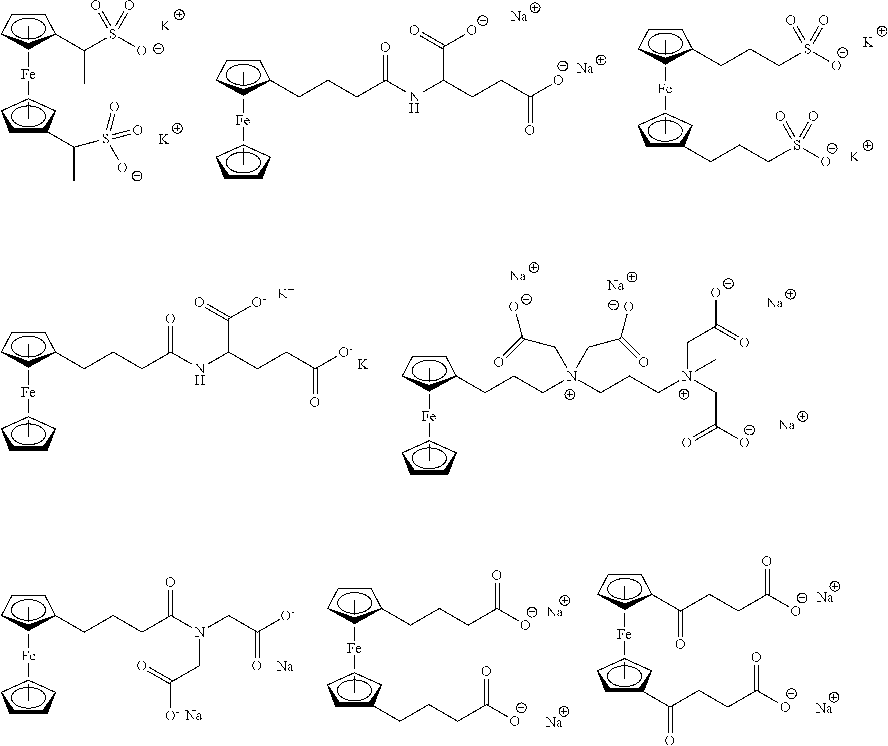

In some embodiments, the ferrocene compounds have the structure of Formula (VI):

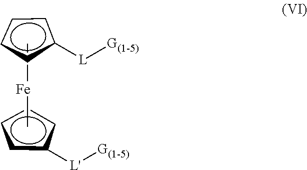

wherein
L is —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, —(C₁-C₁₀)-alkyl-aryl, each optionally substituted by one, two, or more G, —OH, —OCH₃, -halo;
L′ is —H, —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, —(C₁-C₁₀)-alkyl-aryl, each optionally substituted by one, two, or more G, —OH, —OCH₃, -halo;
each G may be independently selected from

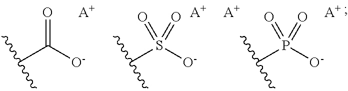

the number of G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl, and may be optionally substituted by one or more G.

In certain embodiments, the L-Gₙ group may have one or more chiral centers. If that is the case, the resulting compound of Formula (VI) may have several stereoisomers. In some embodiments, the compound may be a single stereoisomer. In other embodiments, the compound may be a mixture of two or more stereoisomers in any ratio. The mixture may comprise every stereoisomer of a compound, or it may exclude one or more. If no chirality is indicated at the stereocenter, then the compound may be comprised of any mixture of stereoisomers.

In certain embodiments, the compound of Formula (VI) can be:

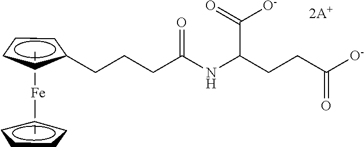

In certain embodiments, the compound of Formula (VI) can be:

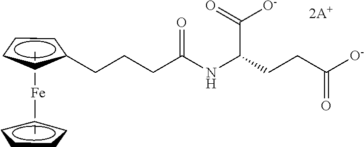

In certain embodiments, the compound of Formula (VI) can be:

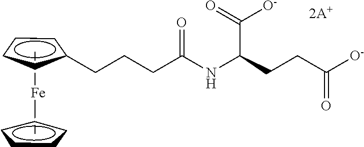

In certain embodiments, the compound of Formula (VI) can be any mixture of the following stereoisomers:

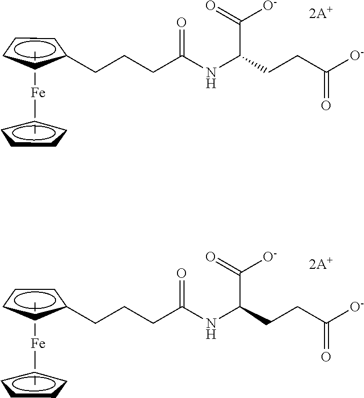

In certain embodiments, the compound of Formula (VI) can be:

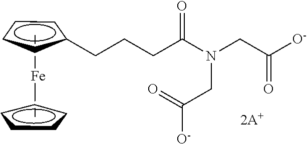

In certain embodiments, the anolyte and/or catholyte solutions may contain a supporting electrolyte. The supporting electrolyte may not be necessary in the anolyte and/or catholyte solutions in several embodiments. Any supporting electrolyte can be used including (but not limited to) inorganic salts and organic salts. Representative inorganic salts include (but are not limited to) NaCl, KCl, LiCl, NaBr, KBr, LiBr, NaI, Kl, LiI, MgCl₂, CaCl₂), MgBr₂, CaBr₂, Mgl₂, and Cal₂, NH₄Cl, NH₄Br, and NH₄I. Representative organic salts include (but are not limited to) alkylammonium chloride, alkylammonium bromide, alkylammonium iodide, sodium tosylate, and sodium besylate. In some embodiments, the solution may also contain co-solvents including (but not limited to) sulfolane or propylene carbonate.

Many embodiments provide redox flow batteries that comprise the aqueous anolyte and catholyte solutions described above. The anolyte and catholyte solutions can be pumped through tubing into the half cells where they undergo electrochemical reactions. The anolyte and catholyte solutions can be cycled through the half cells in repeated charge and discharge cycles. The materials used to fabricate the battery need to be compatible with the anolyte and catholyte solutions to ensure long lifetime of the battery. Redox flow batteries fabricated from common materials in accordance with several embodiments can be manufactured at low costs without compromising the lifetime of the batteries. In certain embodiments, the materials can be manufactured using techniques including (but not limited to) melt-processes, thermoforming processes, injection molding, blow forming, extrusion, additive manufacturing, or 3D printing. In several embodiments, the materials used to fabricate the battery include non-fluorinated polymers that are designated as non-highly chemically resistant. In some embodiments, the materials used to fabricate the battery can be made from ubiquitous hydrocarbon plastics and rubbers. In a number of embodiments, the materials used to fabricate the battery may be polyethers (e.g., PEEK or POM), polynitriles (e.g., ABS or BUNA-N), polyolefins (e.g., EPDM or santoprene rubber or neoprene rubber) or latex or ABS, polyhalides (e.g., PVC), polyureas (e.g., polyurethane). polycarbonates (e.g., polycarbonate), amides (e.g., nylon), and polyaromatics (e.g. polystyrene or BUNA-S).

In some embodiments, at least one of the materials used to fabricate the battery is polyethylene. In several embodiments, at least one of the materials used to fabricate the battery is polypropylene. In certain embodiments, at least one of the materials used to fabricate the battery is polycarbonate. In several embodiments, at least one of the materials used to fabricate the battery is propylene carbonate. In many embodiments, at least one of the materials used to fabricate the battery is polyoxomethylene. In some embodiments, at least one of the materials used to fabricate the battery is EPDM. In various embodiments, at least one of the materials used to fabricate the battery is polyurethane. In several embodiments, at least one of the materials used to fabricate the battery is nylon. In some embodiments, at least one of the materials used to fabricate the battery is PVC. In certain embodiment, at least one of the materials used to fabricate the battery is latex or natural latex rubber. In several embodiments, at least one of the materials used to fabricate the battery is gum rubber. In various embodiments, at least one of the materials used to fabricate the battery is santoprene rubber or santoprene. In several embodiments, at least one of the materials used to fabricate the battery is PMMA. In some embodiments, at least one of the materials used to fabricate the battery is Neoprene. In certain embodiments, at least one of the materials used to fabricate the battery is PEEK. In several embodiments, at least one of the materials used to fabricate the battery is sodium besylate. In some embodiments, at least one of the materials used to fabricate the battery is sodium tosylate. In a number of embodiments, at least one of the materials used to fabricate the battery is BUNA-N.

Polymers can contain additional additives such as plasticizers, colorants, fillers, and stabilizers embedded within the material to tune performance. For example, common additives in polyethylene and PVC can include phthalates and adipate esters. The perylene diimide anolytes in accordance with many embodiments are compatible with the common plasticizers, colorants, fillers.

### Redox Flow Battery

A unit cell of a redox flow battery can include two half-cells. One of the two half cells can be the cathode half-cell, and the other can be the anode half-cell. Catholyte (or cathode electrolyte) can be pumped into the cathode half-cell, and anolyte (or anode electrolyte) can be pumped into the anode half-cell. The cathode half-cell and the anode half-cell can be connected with a membrane for ion transport. The half-cells of the battery include various components including (but not limited to) electrodes, gaskets, flow plates, bipolar plates, and membranes. Any or all of the components of the half-cells can be fabricated from non-fluorinated polymers that are not designated as highly chemically resistant in accordance with several embodiments. In many embodiments, the redox flow batteries can include at least one unit cell; or at least 2 unit cells; or at least 5 unit cells; or at least 10 unit cells; or at least 15 unit cells; or at least 20 unit cells; or at least 25 unit cells; or at least 30 unit cells; or at least 50 unit cells; or at least 100 unit cells; or at least 150 unit cells.

In many embodiments, the redox flow batteries can include a first half-cell comprising an anolyte solution and a second half-cell comprising a catholyte solution, wherein the anolyte solution is comprised of an aqueous soluble perylene diimide molecule, and wherein one or more of the battery components (e.g., electrodes, gaskets, flow frame, bipolar plates, membrane) are made from materials that are not designated as highly chemically resistant. The redox flow cell can be constructed of at least one hard material for the flow frame, hard plumbing connections and electrolyte tanks, at least one soft material for the seals and soft tubing, a conductive hard material for the flow field, a conductive porous electrode, and a membrane. In some embodiments, the battery components can be made from non-fluorinated polymers. In several embodiments, the non-fluorinated polymer can be a polyolefin, a polyether, polyketone, a polyamide, a polyurea, a natural rubber, or a combination thereof.

The flow frame of a redox flow battery is the reaction vessel where charging and discharging takes place. It contains the porous electrode and is exposed to the active electrolyte as it flows. In certain embodiments, the reaction vessel (flow frame) defining the half-cell interiors of the battery can be made of at least one non-fluorinated polymer. Examples of non-fluorinated polymers that can be used to manufacture the flow frames include (but are not limited to) polyethylene, polypropylene, PMP, polybutene-1, PVC, polystyrene, PMMA, ABS, nylon, POM, polycarbonate, nylon, PEEK, or a combination thereof. In some embodiments, the reaction vessel can be made of copolymers derived from two or more of the aforementioned polymers. In various embodiments, the flow frame can be made of titanium. In various embodiments, the flow frame can be made of a metal alloy comprising titanium. In several embodiments, the flow frame can be made of stainless steel.

Bipolar plates of a redox flow battery are in direct contact with electrolyte solution and collect current while separating cells within stacks. Bipolar plates should exhibit high chemical and mechanical stability, high electrical conductivity, and impermeability to prevent leakage. Vanadium redox flow batteries conventionally use isomolded graphite bipolar plates as they possess good chemical stability in addition to electrical conductivity. However, the isomolded graphite plates are expensive to machine and are prone to breaking and leaking as graphite is brittle and highly porous. The perylene diimide anolytes in accordance with some embodiments allow for the use of carbon-polymer composite materials or graphite-resin blends to manufacture bipolar plates. In certain embodiments, the bipolar plates in the anolyte half-cell, or both the anolyte and catholyte half-cells, can be made of extruded graphite. In several embodiments, the bipolar plate in the half cell comprising the anolyte, or in both the anolyte and catholyte half-cells, can be made of a graphite/polymer composite. The graphite/polymer composites can be injection molded or bulk molded. In certain embodiments, the graphite/polymer composite is resin-filled graphite. In a number of embodiments, the polymer of the graphite/polymer composite is polyethylene or polypropylene.

Gaskets are rubber seals placed in between each layer of the half cell (e.g., between the flow frame and the bipolar plate). In many embodiments, the gaskets in the anolyte half-cell, or both the anolyte and catholyte half-cells, in contact with the electrolyte solution, can comprise a non-fluorinated elastomeric material. In some embodiments, the non-fluorinated elastomeric material can be a non-highly chemical-resistant rubber material including (but not limited to) EPDM, santoprene, neoprene, BUNA-S, BUNA-N, latex, trans-isoprene, PUR, and polyurethane.

The membrane in the redox flow battery separates the anode and cathode sides. The membrane should prevent the crossover of active species for each half-cell, and should have high ionic conductivity, low area electrical resistance, and good chemical stability. In several embodiments, the membranes can be ion-exchange membranes or size-exclusion membranes. In some embodiments, the membranes can be made from non-fluorinated polymers. In a number of embodiments, the membranes can be made from hydrocarbon polymers including (but not limited to) polyethylene, polypropylene, polystyrene. These hydrocarbon membranes include non-fluorinated charge conducting groups including (but not limited to) ammoniated polystyrenes, sulfonated polystyrenes, and sulfonated polyether ketones.

In many embodiments, the membrane frames of the redox flow batteries can be made of non-fluorinated polymers. In several embodiments, the membrane frames can be made of non-fluorinated polymers including (but not limited to) polyethylene, polypropylene, PMP, polybutene-1, PVC, polystyrene, PMMA, ABS, nylon, POM, polycarbonate, PEEK, or a combination thereof. In some embodiments, the membrane frames can be made of copolymers derived from two or more of the aforementioned polymers.

Redox flow batteries can include supply lines and/or tubings positioned outside the anodes and cathodes that supply the battery with the electrolytes and carry the electrolytes back to the storage tank. In several embodiments, the supply lines of the redox flow batteries can be fabricated from non-highly chemical-resistant materials. In certain embodiments, the supply lines can be constructed from non-fluorinated polymers. In some embodiments, the supply lines can be fabricated from non-fluorinated elastomeric material. In various embodiments, the non-fluorinated elastomeric material can be a non-highly chemical-resistant rubber material including (but not limited to) EPDM, santoprene, neoprene, BUNA-S, BUNA-N, latex, trans-isoprene, PUR, and polyurethane.

Redox flow batteries can include supply manifolds and electrolyte tanks to supply the electrolyte. In many embodiments, the supply manifolds and/or the electrolyte tanks can be made of at least one non-fluorinated polymer. Examples of non-fluorinated polymers that can be used to manufacture the flow frames include (but are not limited to) polyethylene, polypropylene, PMP, polybutene-1, PVC, polystyrene, PMMA, ABS, nylon, POM, polycarbonate, nylon, PEEK, or a combination thereof. In some embodiments, the supply manifolds and/or the electrolyte tanks can be made of copolymers derived from two or more of the aforementioned polymers.

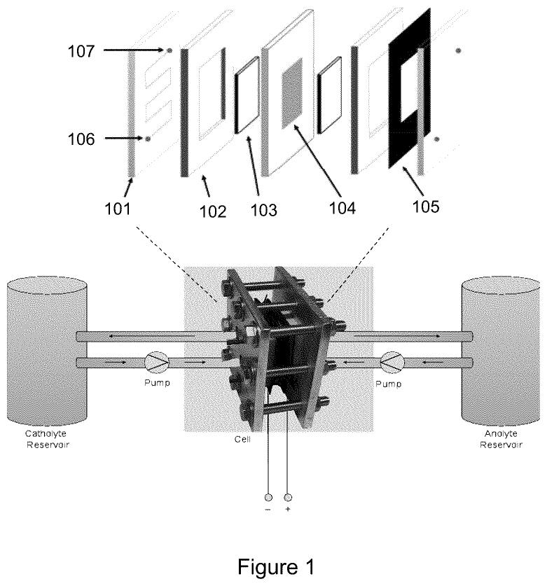

In a redox flow battery, the number of cells (the cell stack) can determine the power output of the system (watts), whereas the electrolyte can be contained within tanks and the size of the tanks can determine the energy (watt hours). This engineered separation of power and energy can be an advantage that enables facile scaling of redox flow batteries. FIG. 1 illustrates a schematic of a redox flow cell with non-highly chemical resistant materials in accordance with an embodiment. A redox flow cell connects with a catholyte reservoir and an anolyte reservoir. The flow cell contains bipolar plates 101, flow frames 102, porous electrodes 103, membranes and membrane frames 104, and gasket (sealing layers) 105. Electrolyte (anolyte or catholyte) solution can be flowed through flow inlets in a conductive charge collecting plate (in a single cell) or a bipolar plate (in a cell stack). The plate can be carved with a flow field that aids the distribution of the electrolyte as it diffuses into the carbon felt electrode. The electrode is contained within the non-conducting flow frame 102. The flow frame 102 can be a chamber in which the electrolyte can charge and discharge. The flow frame 102 is separated from the other half of the cell by an ion-conducting membrane 104 that lets charged ions cross but retains the electrolyte molecules. Electrolyte is then allowed to diffuse out of the electrode and exits the flow outlet 107 on the opposite side of the charge collecting plate or the bipolar plate 101. The two half-cells can be pressed into contact with each layer sealed by a gasket 105 that prevents leaking.

In a conventional vanadium redox flow battery, the bipolar plates can be made of isomolded graphite; the flow frames can be made of PTFE; the porous electrodes can be made of carbon felt; the membranes can be made of Nafion™; the membrane frames can be made of PTFE; and the gasket (sealing layers) can be made of Viton rubber.

The redox flow batteries in accordance with many embodiments implement perylene diimide-based molecules in anolyte for charge storage, such that the cell can be made with non-fluorinated and low-cost materials. In several embodiments, the bipolar plates 101 can be made with resin filled graphite composite; the flow frames 102 can be made with polypropylene; the porous electrodes can be made with carbon felt; the membranes 104 can be made with Selemion™; the gaskets 105 can be made with Santoprene. Polypropylene is a ubiquitous, melt formable thermoplastic. Polypropylene is inexpensive, can be mass produced, and higher stiffness compared to polyethylene. In certain embodiments, the back plate, flow frame, hosing connections, and/or electrolyte tanks can be constructed from polypropylene. Santoprene is a thermoplastic vulcanizate elastomer comprising EPDM rubber encapsulated in a matrix of polypropylene. The addition of polypropylene in this material reduces cost versus pure EPDM and also allows Santoprene to melt and work like a thermoplastic. Santoprene is commonly found as a component of seals, hoses, and flexible connections. Santoprene can be used for seals and flexible tubing in accordance with some embodiments. Impregnated graphite is less expensive than the pyrolytic grades necessitated for corrosive vanadium redox flow batteries. Selemion™ AMVN can be used as the ion exchange membrane. Selemion™ AMVN is a water desalination membrane that is stable in the mild and pH-neural electrolytes. These materials significantly lower the cost of each of these components. Many embodiments provide that the cost associated with manufacturing the components of the redox flow batteries are significantly less than the cost of manufacturing redox flow batteries made with conventional vanadium redox flow battery materials.

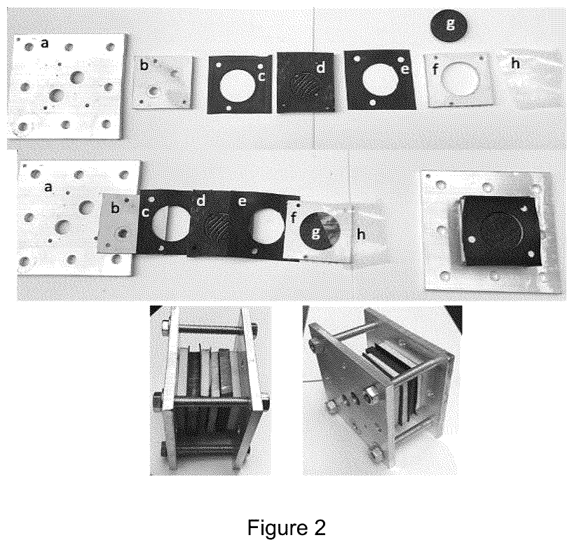

FIG. 2 illustrates the components of a redox flow cell and the assembled redox flow cell in accordance with an embodiment of the invention. The end plates (a) can be made with aluminum fitted together with bolts as a press to provide sealing pressure to the cell. The cell back plate (b) can be constructed from polypropylene and acts as an insulating layer between the charge collecting plate and the metallic press while also provides a surface to connect the fluid inlet and outlet (via polypropylene barb connectors). Between this layer and the charge collecting plate is a flat Santoprene seal (c). Seals in conventional vanadium systems are made of fluorinated elastomers like PFA or Viton due to the corrosive nature of the battery media. Many embodiments use inexpensive Santoprene seals in redox flow batteries. The charge collecting plate (d) is carved with a flow field and drilled with an inlet and an outlet hole for supply. A resin-impregnated graphite can be used for the bipolar plate or the charge collecting plate. The resin-impregnated graphite is both liquid tight and less expensive than the high grade, isomolded graphite where a resin would be degraded by the acidic electrolyte. The charge collecting plate is separated from the flow frame by another Santoprene gasket (e). The flow frame can be constructed from polypropylene and has a void into which a carbon felt electrode (g) is set. These components make up one half of the cell which is separated from the other half by a membrane (h). Selemion™ AMVN, a polystyrene-based membrane can be used as the membrane. The second half of the cell is the mirror image of the first and the construction of the cell is illustrated in FIG. 2. The total cell area (a 1-inch circle) can be about 5 cm²; or less than about 5 cm²; or greater than about 5 cm²; from about 5 cm² to about 100 cm²; greater than about 100 cm²; from about 100 cm² to about 500 cm²; from about 500 cm² to about 1500 cm²; greater than about 1500 cm². All tubing supplying the cell via centrifugal pump can be made of polymers including (but not limited to) PVC and the electrolyte supply tanks can be made with plastics, polymers, or glass.

### Redox Flow Battery Performance

The perylene diimide disclosed herein provide stability for a long lifetime redox flow battery. The ferrocene disclosed herein provide stability for a long lifetime redox flow battery. As used herein, the term “long lifetime” refers to a battery having stable capacity retention over repeated charge cycles or temporal time. In some embodiments, the redox flow batteries can have a lifetime of at least 5 years; or a lifetime of at least 10 years; or a lifetime of at least 20 years; or a lifetime of at least 50 years; or a lifetime of between 5 years and 50 years; or a lifetime of between 5 years and 50 years; or a lifetime of between 20 years and 50 years.

Coulombic efficiency is a direct measure of molecular stability in an organic flow battery. Coulombic efficiency is the number of electrons out of the battery, compared to the number put in. For example, if the battery discharges 99 electrons from 100 electrons charged into the device in a given cycle, it has a coulombic efficiency of 99%. This can be a direct measure of molecular stability in an organic flow battery. Electrons can be lost in a variety of ways aside from molecular decomposition, such as leakage of solution out of the cell or crossover of active species across the membrane. However, molecular decomposition is observed as coulombic efficiency loss. Although not all coulombic efficiency loss is due to molecular decomposition, molecular decomposition can lead to coulombic efficiency loss. It is possible for the molecules to be more stable than coulombic efficiency is showing, if leakage is the reason for a loss in coulombic efficiency. On the other hand, the molecule may not be less stable than coulombic efficiency shows. Any molecular decomposition will result in coulombic efficiency decrease. An example of such decomposition can be when the organic radical on the charged molecule is quenched due to a destructive chemical event such as dimerization and the formation of a permanent bond using two radicals or solvent attack. A coulombic efficiency that shows a 500-year lifetime may have a molecular stability of 750-years, but may not have molecular stability less than the 500-year the coulombic efficiency shows.

In many embodiments, the redox flow batteries comprising stable and water-soluble perylene diimide anolytes as well as stable and water-soluble ferrocenes, exhibit high coulombic efficiencies at neutral pH (pH at about 7) or pH levels close to neutral (pH from about 6 to about 8; or pH from about 5.5 to about 8.5). In several embodiments, the coulombic efficiency of the redox flow batteries can be at least 98% after at least about 200 charge/discharge cycles; or after at least 380 charge/discharge cycles. In some embodiments, the coulombic efficiency can be at least 98.5% at least about 200 charge/discharge cycles; or after at least 380 charge/discharge cycles. In certain embodiments, coulombic efficiency is at least 99% after at least about 200 charge/discharge cycles; or after at least 380 charge/discharge cycles. In several embodiments, the coulombic efficiency is at least 99.5% after at least about 200 charge/discharge cycles; or after at least 380 charge/discharge cycles. In some embodiments, coulombic efficiency is at least 99.6% after at least about 200 charge/discharge cycles; or after at least 380 charge/discharge cycles. In certain embodiments, coulombic efficiency is at least 99.7% after at least about 200 charge/discharge cycles; or after at least 380 charge/discharge cycles. In many embodiments, coulombic efficiency is at least 99.9% after at least about 200 charge/discharge cycles; or after at least 380 charge/discharge cycles. In some embodiments, coulombic efficiency is about 100% after at least about 200 charge/discharge cycles; or after at least 380 charge/discharge cycles. In several embodiments, the coulombic efficiency is between about 98.5% and about 99.5% after at least about 200 charge/discharge cycles; or after at least 380 charge/discharge cycles. In certain embodiments, the coulombic efficiency is between about 99% and about 99.5% after at least about 200 charge/discharge cycles; or after at least 380 charge/discharge cycles. In several embodiments, the coulombic efficiency is between about 99.5% and about 99.9% after at least about 200 charge/discharge cycles; or after at least 380 charge/discharge cycles.

The high coulombic efficiencies of the redox flow batteries in accordance with many embodiments enable long lifetimes of the charge storage species in the batteries. In several embodiments, the half-life of the species in the batteries (i.e., time needed for the battery to lose half of its charge storing ability due to molecular degradation) can be greater than about 10 years. In some embodiments, the half-life of the charge storage materials for redox flow batteries can be greater than about 20 years. In certain embodiments, the half-life of the charge storage materials for redox flow batteries can be greater than about 50 years. In some embodiments, the half-life of the charge storage materials for redox flow batteries can be greater than about 70 years. In several embodiments, the half-life of the charge storage materials for redox flow batteries can be greater than about 100 years. In various embodiments, the half-life of the charge storage materials for redox flow batteries can be greater than about 200 years. In many embodiments, the half-life of the charge storage materials for redox flow batteries can be greater than about 500 years. In some embodiments, the half-life of the charge storage materials for redox flow batteries can be greater than about 1,000 years. In several embodiments, the half-life of the charge storage materials for redox flow batteries can be greater than about 2,000 years. In certain embodiments, the half-life of the charge storage materials for redox flow batteries can be greater than about 3,000 years. In some embodiments, the half-life storage materials for redox flow batteries of the disclosure can be greater than about 5,000 years. In a number of embodiments, the half-life of the charge storage materials for redox flow batteries is between about 50 years and about 100 years. In some embodiments, the half-life of the charge storage materials for redox flow batteries is between about 100 years and about 500 years. In various embodiments, the half-life of the charge storage materials for redox flow batteries is between about 500 years and about 1,000 years. In some embodiments, the half-life of the charge storage materials for redox flow batteries is between about 1,000 years and about 2,000 years. In several embodiments, the half-life of the charge storage materials for redox flow batteries is between about 2,000 years and about 3,000 years. In certain embodiments, the half-life of the charge storage materials for redox flow batteries is between about 2,000 years and about 5,000 years.

The performance of a redox flow battery can be measured by its capacity retention. If a redox flow battery loses minimal charge storing capacity during multiple charge/discharge cycles, it can ensure sufficient lifetime for the battery. The redox flow batteries in accordance with many embodiments lose negligible charge storage capacity over multiple charge/discharge cycles. In some embodiments, the redox flow batteries lose less than about 2% charge storing capacity after about 300 full charge/discharge cycles; or after about 380 full charge/discharge cycles. In several embodiments, the redox flow batteries lose less than about 1% charge storing capacity after about 300 full charge/discharge cycles; or after about 380 full charge/discharge cycles. In certain embodiments, the redox flow batteries lose less than about 0.5% charge storing capacity after about 300 full charge/discharge cycles; or after about 380 full charge/discharge cycles. In various embodiments, the redox flow batteries lose less than about 0.25% charge storing capacity after about 300 full charge/discharge cycles; or after about 380 full charge/discharge cycles. In a number of embodiments, the redox flow batteries lose less than about 0.1% charge storing capacity after about 300 full charge/discharge cycles; or after about 380 full charge/discharge cycles. In some embodiments, the redox flow batteries lose less than about 0.05% charge storing capacity after about 300 full charge/discharge cycles; or after about 380 full charge/discharge cycles. In several embodiments, the redox flow batteries lose less than about 0.03% charge storing capacity after about 300 full charge/discharge cycles; or after about 380 full charge/discharge cycles. In some embodiments, the redox flow batteries lose less than about 0.01% charge storing capacity after about 300 full charge/discharge cycles; or after about 380 full charge/discharge cycles. In certain embodiments, the redox flow batteries lose between about 0.05% and about 0.1% charge storing capacity after about 300 full charge/discharge cycles; or after about 380 full charge/discharge cycles. In several embodiments, the redox flow batteries lose between about 0.03% and about 0.1% charge storing capacity after about 300 full charge/discharge cycles; or after about 380 full charge/discharge cycles. In some embodiments, the redox flow batteries lose between about 0.01% and about 0.05% charge storing capacity after about 300 full charge/discharge cycles; or after about 380 full charge/discharge cycles.

Many embodiments provide that the redox flow batteries lose minimal charge storing capacity during operation. In some embodiments, the redox flow batteries lose less than about 2% charge storing capacity per year. In several embodiments, the redox flow batteries lose less than about 1% charge storing capacity per year. In certain embodiments, the redox flow batteries lose less than about 0.5% charge storing capacity per year. In certain embodiments, the redox flow batteries lose less than about 0.25% charge storing capacity per year. In some embodiments, the redox flow batteries lose less than about 0.1% charge storing capacity per year. In several embodiments, the redox flow batteries lose less than about 0.05% charge storing capacity per year. In certain embodiments, the redox flow batteries lose less than about 0.03% charge storing capacity per year. In some embodiments, the redox flow batteries lose less than about 0.01% charge storing capacity per year. In various embodiments, the redox flow batteries lose between about 0.05% and about 0.1% charge storing capacity per year. In several embodiments, the redox flow batteries lose between about 0.03% and about 1% charge storing capacity per year. In various embodiments, the redox flow batteries lose between about 0.01% and about 0.05% charge storing capacity per year.

### Exemplary Embodiments

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

### Example 1: Non-Highly Chemical Resistant Materials

Many embodiments utilize common plastic and rubber materials that are easy to source and manufacture in redox flow batteries. Various plastics, rubbers, and small molecules are compatible with the redox flow batteries due to the mild working conditions of the battery such as neutral electrolyte solution and non-corrosive redox molecules. Examples of plastics that are compatible with the redox flow batteries include (but are not limited to) nylon, PEEK, POM, PVC, PE, PMMA and PP. The plastic materials in accordance with some embodiments can be used for constructing wetted parts such as the flow frame, supply manifolds, and electrolyte tanks. Examples of flexible materials (rubbers and elastomers) include (but are not limited to) EPDM, Neoprene, silicone, BUNA-N, latex, PUR, and Santoprene. The flexible materials in accordance with several embodiments can be used for seals, tubing, and other parts of the battery system where flexibility is desired. Examples of metals include (but are not limited to) 316 stainless steel, 6061 aluminum, hastelloy, and grade 2 titanium. Some embodiments provide small molecules including (but not limited to) sodium besylate, sodium tosylate, propylene carbonate, and sulfolane, are compatible with the redox flow batteries. The small molecules can be added to the electrolyte solutions at concentrations many times that of the charge-carrying molecules for stability testing. These small molecules represent functional groups of interest in high-concentration stress tests to verify that the electrolytes would not interact with a certain class of structure. Sodium besylate a form of aromatic sulfonic acid sodium salt and represents a functional group grafted to the polystyrene backbone of the Selemion™ AMVN anion exchange membrane. Dosing it in at gross excess can determine whether there are inherent stability problems with aryl sulfonates either present in, or leaching from the anion exchange membrane. Sodium tosylate has the added structural motif of a benzylic carbon (the methyl group) and serves as a water-soluble test of the stability of this position, which can undergo radical-promoted reactions under certain conditions. Propylene carbonate and sulfolane are non-volatile solvents of interest for their viscosity-reducing properties. The chemical structures of the materials are displayed in Table 1. The stability of the materials in H-Cell cycling tests and high-SOC exposure tests as detailed below.

TABLE 1
Chemical structures and formulas of non-highly chemical resistant materials.
Plastic

| Name | Structure |
|---|---|
| Nylon | 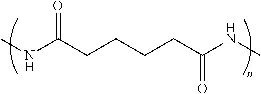 |
| Polyether Ether Ketone (PEEK) | 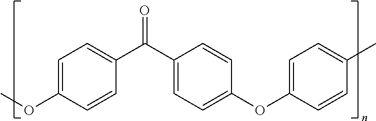 |
| Polyoxo- methylene (POM) | 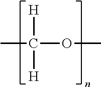 |
| Poly(vinyl chloride (PVC) | 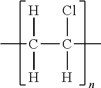 |
| Polyethylene (PE) | 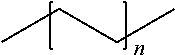 |
| Polymethyl Methacrylate (PMMA) | 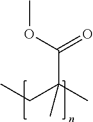 |
| Polypropylene (PP) | 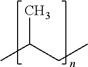 |

Rubber

| Name | Structure |
|---|---|
| EPDM | 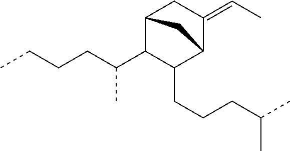 |
| Neoprene | 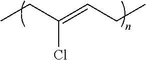 |
| Silicone | 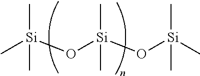 |
| Butadiene- Acrylonitrile (BUNA-N) | 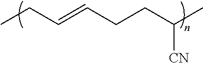 |
| Latex | 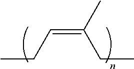 |
| Polyurethane | 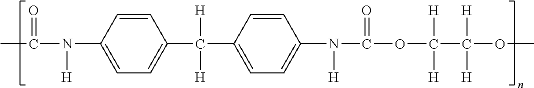 |
| Santoprene (EPDM encapsulated in PP) | 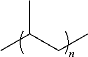 |

Small molecule

| Name | Structure |
|---|---|
| sodium besylate | 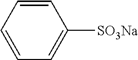 |
| sodium tosylate | 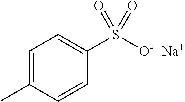 |
| propylene carbonate | 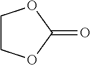 |

Metal

| Name | Composition |
|---|---|
| 316 Stainless Steel | Fe with: 16-18% Cr, 2-3% Mo, 10-14% Ni |
| 6061 Aluminum | Al with: 0.8-1.2% Mg, 0.4-0.8% Si |

### Example 2. H-Cell Experiments

Many embodiments implement redox flow cells including (but not limited to) H-cells to test the compatibility of the electrolyte solutions in the charged and uncharged state with cell fabrication material through exposure to the material in a glass H-cell transposed with a membrane. The cell fabrication material is placed into the half-cell of the H-cell to be analyzed for compatibility. This static cell experimental setup allows for the accurate measurement of coulombic efficiency to analyze the electrochemical and physical compatibility of the charged electrolyte solution with a cell fabrication material. A high coulombic efficiency shows that the electrons placed into the organic charge storage electrolyte upon charging are returned upon discharge, meaning that the electrolyte does not electrochemically or physically react with the cell fabrication material, while in the charged state and thereby quench the charge. Additionally, this static cell experiment allows for sampling of the H-cell via removal of aliquots over time for High Performance Liquid Chromatography analysis. This analysis shows new molecular species arising from reactivity of the electrolyte in a state of charge with various materials in the cell. No generation or slow generation of new molecular species indicates compatibility.

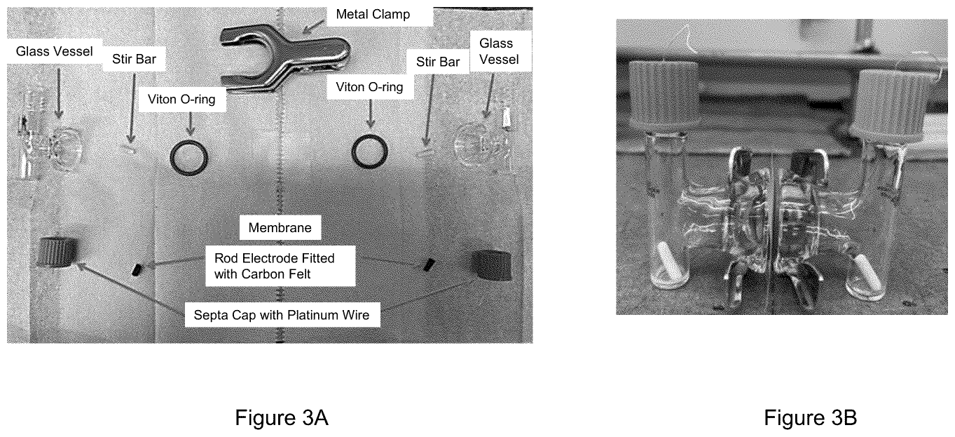

A glass H-cell with 1 mAh theoretical capacity can be used for material stability tests. FIG. 3A illustrates various components for an H-cell. FIG. 3B illustrates an assembled H-cell. The H-cell includes two glass chambers, a metal clamp, a membrane, two carbon felt electrodes connected to the battery cycler via platinum wire, two PTFE stir bars, two Viton O-rings, and two septa caps. To assemble the H-cell, the two glass chambers can be connected and held in place via a metal clamp, wherein the membrane can be fastened between the two halves to separate the sides. One side is the anodic half and the other side is the cathodic half. The membrane can be sealed with two Viton O-rings, one on each side of the membrane. One PTFE-coated stir bar can be placed in each glass chamber in the H-cell. A thin platinum wire can be inserted through the septa cap, in order to connect the external load to the carbon felt electrodes, which are fixed to the end of the wire, through the septa cap. Then, one septa cap can be put at both the anode and cathode. An empty H-Cell without electrodes can be assembled outside the glovebox. The empty H-cell can be purged and backfilled with nitrogen atmosphere in antechamber at least three times, and then transferred to a glovebox. The felt electrodes can be attached to the platinum wire at both anode and cathode, and the cell be filled with deoxygenated anolyte and catholyte solution.

The anolyte and catholyte solutions are the electrolytes used at anode and cathode in the H-cell, respectively. The anolytes can be perylene diimide (PDI) and/or any of perylene diimide in accordance with many embodiments. The catholyte can be ferrocene and/or any of ferrocene derivative in accordance with several embodiments. Some embodiments implement PDI-tetraammonium-Cl₄ in the anolyte half-cell and ferrocene-diammonium-Cl₂ in the catholyte half-cell for the H-cell tests. As can be readily appreciated, any form of PDI derivative can be used in the anolyte and any form of ferrocene derivative can be used in the catholyte as appropriate to the requirements of specific applications in accordance with various embodiments of the invention. The electrolyte can be dissolved in about 1 M sodium chloride for electrochemical stability testing. The moles of anolyte and catholyte molecules present can be controlled to achieve the desired capacity of 1 mAh. During the charge-discharge cycle, the PDI-tetraammonium-Cl₄ accepts and donates two electrons per molecule, whereas the ferrocene-diammonium-Cl₂ only accepts and donates one electron per molecule. Thus, the molar concentration of PDI-tetraammonium-Cl₄ is half of that of ferrocene-diammonium-Cl₂ in the H-Cell. Selemion™ anion exchange membrane (AMVN) can be used for the H-cells. Selemion™ AMVN is a polystyrene-based ion-exchange membrane. Materials used in the construction of the H-Cells such as glass, Viton, PTFE, platinum, and carbon, have shown no unfavorable interactions with the electrolytes in cycling tests.

For the compatibility H-cell tests, the anode and cathode side have approximately 7 mL of anolyte and catholyte, respectively. After the H-cell is equipped with rod electrodes and filled with electrolyte in the glovebox, the H-cell can be connected to a battery testing system. The H-cell can be placed onto a magnetic stirrer before cycling. The operational temperature of the H-Cell is between about 30° C. and about 38° C. The capacity of the H-cell may vary slightly between tests and depend on the refreshing rate of electrolytes (or the spin speed of the stir bar), the position of electrodes, and the variation of operational temperature.

The H-cells test method includes a constant current and constant voltage protocol. The H-cell can be first rested for about 10 seconds and then charged at a constant current of about 0.25 mA (which corresponds to about 0.25 C charge rate). Once the voltage reaches about 1 V, it is rested for another 30 seconds. Next, about 1 V constant-voltage charge can be applied until the charge current dropped to about 0.05 mA (which corresponds to about 0.05 C charge rate). Afterwards, the H-cell can be fully charged and rested at its open circuit voltage for about 30 seconds. A two-step current discharging method can be employed. The H-cell is discharged at a constant current about 0.25 mA until its voltage drops to about 0.1 V, and then it is discharged at a lower rate until the discharge current is lower than about 0.05 mA. When the first charge-discharge cycle is finished, the same test protocol can be applied continuously for the following cycles.

After a few cycles to establish a baseline, the charge-discharge cycle test is paused, the two septa caps are opened, a small piece of one material can be placed to both chambers of the H-cell, and the two septa caps are returned. Afterwards, the charge-discharge cycle test can be resumed for the H-cell. The cycling tests can last for at least two weeks. Over the period of test, the coulombic efficiency and capacity are monitored. If a coulombic efficiency above 99.9% is not maintained, the material is considered incompatible with the electrolyte in accordance with various embodiments.

H-Cell cycling tests in accordance with many embodiments show compatibility of various materials during weeks long battery cycling with average coulombic efficiencies above about 99.9%. The compatibility of various materials can provide a variety of viable options for structural elements of the battery system. Examples of compatible hard materials include (but are not limited to) nylon, PEEK, POM, PVC, PE, PMMA, and PP. The compatible materials enable low cost redox flow batteries that are easy to fabricate. The materials including (but not limited to) nylon, PE and PP are available as 3D printing filaments which will enable fast prototyping of elements like liquid supply manifolds and flow frames. Examples of compatible soft materials include (but are not limited to) EPDM, Neoprene, BUNA-N, natural latex rubber, PUR, and Santoprene. The soft materials can be used for flexible parts of redox flow batteries including (but not limited to) tubes and seals. However, not all tested materials are compatible with the redox flow batteries in accordance with many embodiments. In certain embodiments, silicone shows a coulombic efficiency of about 99.89% during the H-cell tests. The coulombic efficiency of silicone in the redox flow batteries is less than about the desired 99.9% such that silicone may not be stable to provide the at least 20-year lifetime as desired. Examples of compatible small molecules include (but are not limited to) sodium besylate, sodium tosylate, propylene carbonate, and sulfolane. The stability of sodium besylate and sodium tosylate indicates that the aryl sulfonic acids in the Selemion™ AMVN membrane do not play a negative role in the stability of a cycling battery. Additionally, the stability of sodium tosylate indicates the stability of benzylic methyl groups as a motif in general. Co-solvents can be added to electrolyte formulations to improve solution characteristics such as viscosity, solubility, and volatility. Examples of compatible co-solvents include (but are not limited to) propylene carbonate and sulfolane. The compatibility of propylene carbonate with the redox flow batteries indicates the compatibility of carbonate moiety in general and means polycarbonate plastics and other carbonate-containing molecules can be stable. Some embodiments show that metals such as 316 stainless steel and 6061 aluminum may be inadequate for wetted parts of the redox flow batteries. These alloys contain a variety of transition metals and elements which can be oxidized and reduced electrochemically. Once the battery is charged, electron may migrate from the redox molecules in the electrolyte to these metallic materials and cause degradation. Several embodiments may apply coating to any metal materials used in the redox flow batteries with compatible plastic or rubber materials including (but not limited to) nylon, PEEK, POM, PVC, PE, PMMA, PP, EPDM, neoprene, BUNA-N, latex, Santoprene, polyurethane, and any combinations thereof.

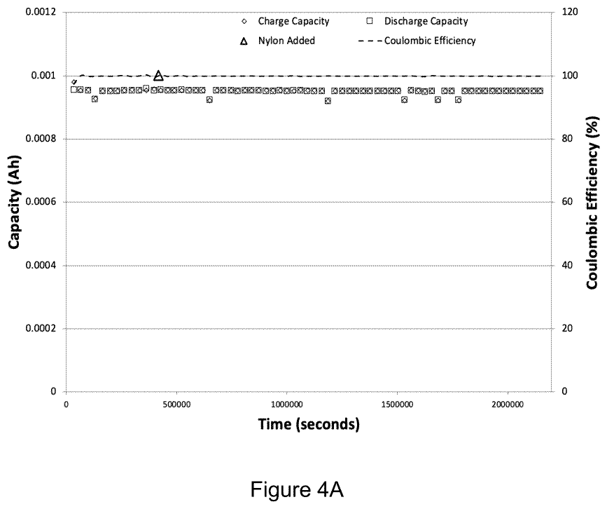

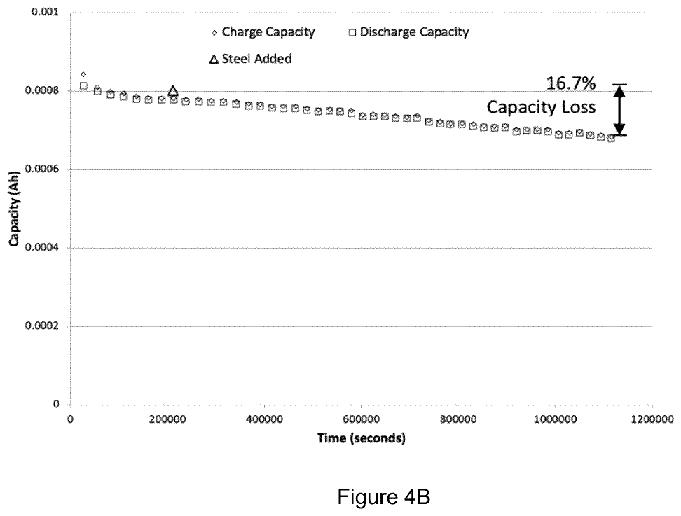

FIG. 4A illustrates H-cell cycling test results with nylon in accordance with an embodiment of the invention. FIG. 4A shows H-cell cycling with Nylon in about 19.9 days, with coulombic efficiency of about 99.95%. With an average coulombic efficiency of about 99.95% over about 20 days, the discharge capacity (orange line) and charge capacity (blue line) are even in every cycle after the addition of nylon to the cell. As shown in FIG. 4A, the capacity of the cell remains flat, showing no detectable decay of nylon in the working condition of the redox flow batteries.

FIG. 4B illustrate H-cell cycling test results with 316 stainless steel in accordance with an embodiment of the invention. FIG. 4B shows H-cell cycling with 316 stainless steel in about 12.9 days, with coulombic efficiency of about 99.32%. The coulombic efficiency for the steel test is at about 99.32%, with a downward trend in capacity being evident. The capacity loss of 316 stainless steel in the redox flow batteries shown in FIG. 4B can be due to discharge into the steel, chemical reaction between the electrolyte and the steel, and/or adsorption of active species into the steel. As the battery capacity decreases to below 99.9% efficiency, a redox flow battery with steel in contact with the electrolyte solutions may be too unstable.

The results of the H-cell cycling tests for exemplary materials are summarized in Table 2. The material is considered stable if the coulombic efficiency is equal to or greater than about 99.9% after at least 14 days of H-cell testing. The material is considered unstable if the coulombic efficiency is less than about 99.9% after at least 14 days of H-cell testing.

TABLE 2
H-cell cycling test results.

| | | | Coulombic | |
|---|---|---|---|---|
| Material | Cycles | Time (days) | efficiency (%) | Stability |
| EPDM | 60 | 18 | 100 | Stable |
| Neoprene | 52 | 20 | 99.97 | Stable |
| Nylon | 56 | 20 | 99.95 | Stable |
| PEEK | 39 | 14 | 99.94 | Stable |
| POM | 57 | 20 | 100 | Stable |
| PVC | 51 | 17 | 100 | Stable |
| Silicone | 28 | 16 | 99.89 | Unstable |
| Sodium besylate | 83 | 26 | 100 | Stable |
| Sodium tosylate | 76 | 25 | 100 | Stable |
| Propylene carbonate | 97 | 31 | 99.94 | Stable |
| Sulfolane | 99 | 31 | 100 | Stable |
| BUNA-N | 27 | 16 | 99.98 | Stable |
| Latex | 50 | 16 | 100 | Stable |
| Polyethylene | 67 | 17 | 100 | Stable |
| PMMA | 52 | 17 | 99.91 | Stable |
| Polypropylene | 28 | 16 | 100 | Stable |
| Polyurethane | 67 | 17 | 100 | Stable |
| Santoprene | 59 | 17 | 100 | Stable |
| 316 Stainless Steal | 47 | 13 | 99.32 | Unstable |
| 6061 Aluminum | 81 | 30 | 97.3 | Unstable |

### Example 3. High States of Charge Exposure Tests

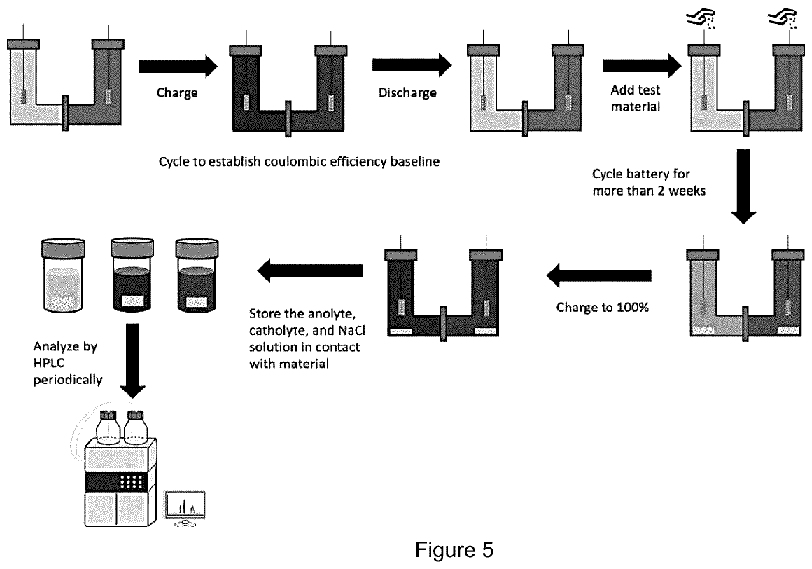

For materials that pass the H-cell cycling tests, high-SOC exposure tests can be performed to test the compatibility with the fully-charged electrolyte over extended periods of time. For the high SOC tests, the H-cell can be charged to 100% state of charge. Next, the cycling can be stopped, and fully charged anolyte and catholyte can be transferred to separated vials. An additional vial with about 1.0 M NaCl in water can be used as the reference. One small piece of material, amounting to a large excess by mass when compared to the electrolyte molecules present in solution, can be placed in each of these three vials. A small amount of sample can be collected from these three vials and tested by HPLC periodically to monitor for chemical changes arising from exposure of charged species to the tested material. The NaCl control can be used to monitor leaching of any constituents from the materials into salt water, as these may go on to interact with the electrolyte. Additionally, both electrolytes exhibit a color change when discharged, giving a quick, qualitative measure of stability. The high SOC tests do not require a battery cycler, leaving cycler channels free for H-Cell experiments and parallelizing workflow. FIG. 5 illustrates a process for the combined H-cell and high-SOC exposure tests for a given material.

The stability, and therefore utility, of each material that with positive results in the H-cell cycling test (Table 2) can be further explored using the high-SOC exposure tests. These tests are performed by storing the charged electrolytes in contact with the tested material for durations of up to about 133 days). The test results indicate interactions that may arise on a longer timescale than the initial cycling tests. Any interaction that would be detrimental to battery longevity, for example: chemical reaction between the electrolyte molecule and the material, or chemical reaction between the electrolyte molecule and a leachate or decomposition product that dissolves from the material into solution, would necessarily result in new chemical species present in the solution which would be detected by HPLC. Additionally, even if innocent, leachates and decomposition products from the materials in contact with salt water would be easily detected as well. If no new chemical products are detected in the anolyte or catholyte solutions and no leachates or decomposition is evident in the salt water control experiments, it can be concluded that no chemical decomposition occurred over the tested time in contact with the material. During the high-SOC tests, small amount of about 15 mg of electrolyte is in the presence of hundreds of milligrams of testing materials such as plastics and/or rubber.

The high-SOC tests can be carried out in parallel to the H-cell tests. For example, polystyrene and polycarbonate can be tested by charging an H-cell to 100% SOC and portioning the electrolytes into vials into which the materials are placed and stored. The results of the high-SOC exposure tests with PDI-tetraammonium-Cl₄ (PDI-XL-2), ferrocene-diammonium-Cl₂ (Fc-XL-2), and NaCl control are summarized in Table 3. The materials that show compatibility in the H-cell tests also show positive results in the exposure tests. Additionally, no amounts above noise of any species leaching from the materials into pure salt water can be detected.

TABLE 3
High-SOC exposure test results.

| Material | Time (days) | Fc-XL-2 | PDI-XL-2 | NaCl control |
|---|---|---|---|---|
| EPDM | 7, 14, 35, 49, 63, 105, 133 | No change | No change | No leaching |
| Neoprene* | 7, 28, 42, 70, 98, 133 | No change | No change | No leaching |
| Nylon* | 7, 28, 42, 70, 98, 133 | No change | No change | No leaching |
| PEEK | 7, 14, 35, 49, 63, 105, 133 | No change | No change | No leaching |
| POM* | 7, 28, 42, 70, 98, 133 | No change | No change | No leaching |
| PVC | 7, 28, 42, 70, 98 | No change | No change | No leaching |
| BUNA-N | 14, 28, 56, 84 | No change | No change | No leaching |
| Latex | 7, 28, 56, 84 | No change | No change | No leaching |
| Polyethylene | 7, 28, 56, 84 | No change | No change | No leaching |
| PMMA | 14, 28 | No change | No change | No leaching |
| Polypropylene | 14, 28, 56, 84 | No change | No change | No leaching |
| Polyurethane | 7, 14, 35, 49, 63, 105, 133 | No change | No change | No leaching |
| Santoprene | 7, 28, 42, 70, 98 | No change | No change | No leaching |
| Polycarbonate* | 7, 28, 42, 70, 98, 133 | No change | No change | No leaching |
| Polystyrene* | 7, 28, 42, 70, 98, 133 | No change | No change | No leaching |

*indicates materials that were tested after charging to 100% without extended cycling

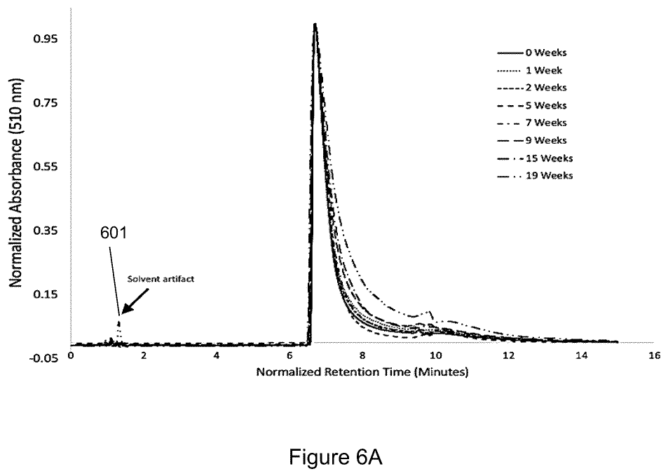

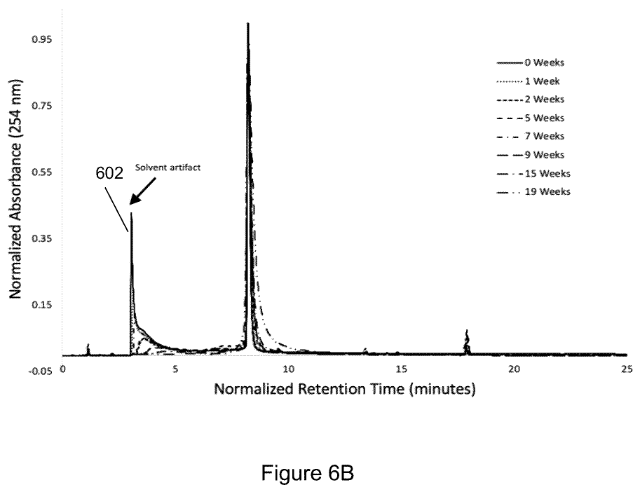

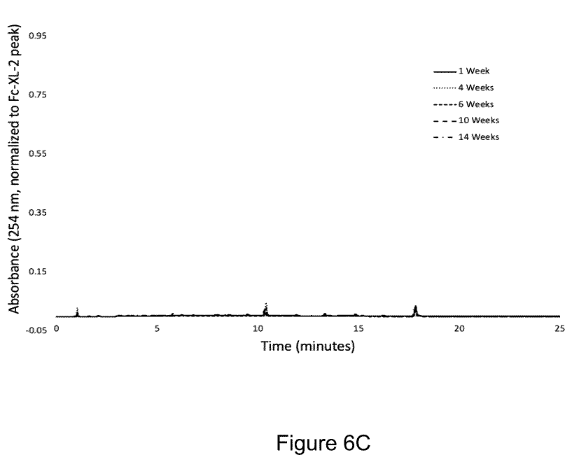

HPLC tests are carried out for all testing materials. FIGS. 6A-6C illustrate HPLC results from a high-SOC exposure test overtime for PDI-tetraammonium-Cl₄, ferrocene-diammonium-Cl₂, and NaCl control upon resting while exposed to EPDM rubber in accordance with an embodiment of the invention. FIG. 6A shows HPLC results from a high-SOC exposure test overtime for PDI-tetraammonium-Cl₄ in contact with EPDM rubber. FIG. 6B shows HPLC results from a high-SOC exposure test overtime for ferrocene-diammonium-Cl₂ in contact with EPDM rubber. FIG. 6C shows HPLC results from a high-SOC exposure test overtime for NaCl in contact with EPDM rubber. Because the samples are diluted to a concentration appropriate for HPLC, there can be some variation introduced in total peak absorbance, for this reason the chromatograms are normalized to the maximum peak height of the sample which has the strongest absorbance at the detected wavelength. Since small changes in temperature and concentration subtly affect retention time, the time can also be normalized to align the maxima of product peaks for PDI-tetraammonium-Cl₄ and ferrocene-diammonium-Cl₂. To make a more direct comparison between the concentrations of any leachates in the salt water blank and the concentrations of the electrolyte molecules, the salt water data is presented on the same scale as the ferrocene-diammonium-Cl₂ data. All chromatography is performed on a C-18 reverse phase column and elution conditions are developed separately for PDI-tetraammonium-Cl₄ and ferrocene-diammonium-Cl₂. For the salt water control experiments, the method for ferrocene-diammonium-Cl₂ is used. Some HPLC spectra contain solvent front artifacts that present as peaks with short retention times and intensities that vary randomly. These signals are a result of the changes in UV-absorption of the carrier solvent upon injection and do not correspond to any chemical species present in the analyte.

For PDI-tetraammonium-Cl₄, the HPLC chromatogram does not change after a very long time (about 19 weeks) spent exposed to EPDM. The small peak 601 visible at about 1.8 minutes is the solvent front of the injection and, unlike a true impurity or decomposition product, its intensity varies randomly between samples instead of growing in over time. The broad and tailing peak shape is typical of a PDI molecule and is attributed to aggregation in solution.

The results obtained for ferrocene-diammonium-Cl₂ upon exposure to EPDM are also positive. The earliest eluting peak, like that for PDI-tetraammonium-Cl₄ is the solvent front of the injection and varies widely from sample to sample, not dependent on concentration or time. Uncharged ferrocene-diammonium-Cl₂ in salt water also presents this peak 602. This is likely a consequence of column and trace product eluting at the solvent front in salt water. NaCl mixed with the polar ferrocene-diammonium-Cl₂ initially elutes very fast on the reverse phase column, after the NaCl has washed and co-eluted with some of the ferrocene-diammonium-Cl₂, the rest of the ferrocene-diammonium-Cl₂ is retained on the column and elutes as a single peak around 8 minutes. There is also a small, sharp signal visible around 18 minutes. This signal as well does not grow with time, and is seen with salt water that has not been exposed to any test material, indicating it is an HPLC column and system artifact present in all samples. Since this peak is present in the absence of ferrocene-diammonium-Cl₂, it is therefore not a decomposition product. It can be seen that there are no new products forming.

### Example 4. Redox Flow Cell Performance

The compatible materials used for building the redox flow batteries do not show signs of degradation, and the flow cells exhibit an average coulombic efficiency of about 100% after testing for about 20 days. The electrolyte supply tanks of the flow cell can be filled with PDI-tetraammonium-Cl₄ and ferrocene-diammonium-Cl₂ as the anolyte and catholyte, respectively, in accordance with several embodiments. The flow rate can be set to approximately 10 mL/min and the battery can be cycled similar to the H-cell stability tests.

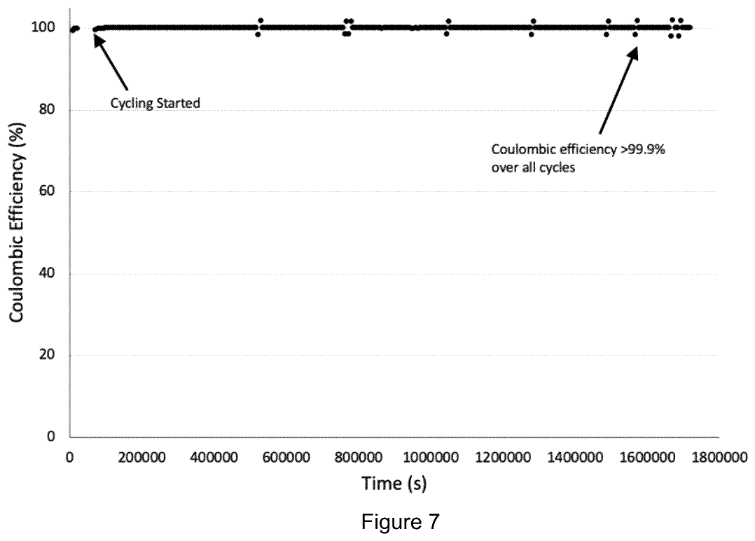

FIG. 7 illustrates the cycling data from 10 mAh flow cell in accordance with an embodiment of the invention. Initially, pumping inconsistencies are experienced which account for a small delay in the data collection but after equilibrating, electrolyte supply is maintained and the cycling test begins. The flow cell is cycled for about 20 days and about 380 cycles. This long-term cycling test in FIG. 7 shows higher than 99.9% coulombic efficiency. The average coulombic efficiency is about 100%.

### Example 5: Battery Fabricated from Non-Highly Chemical-Resistant Materials

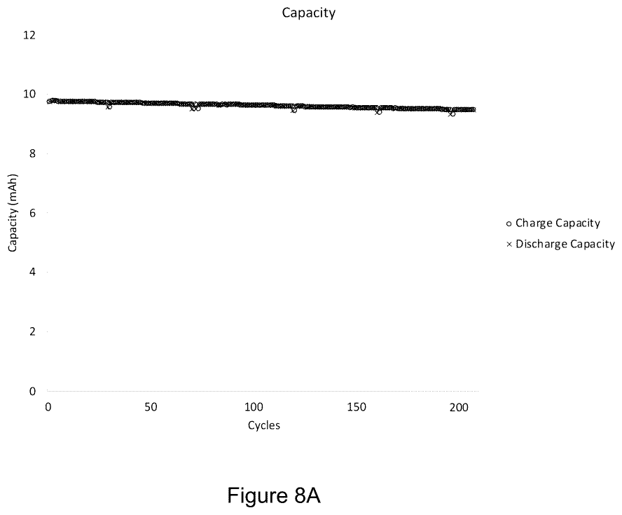

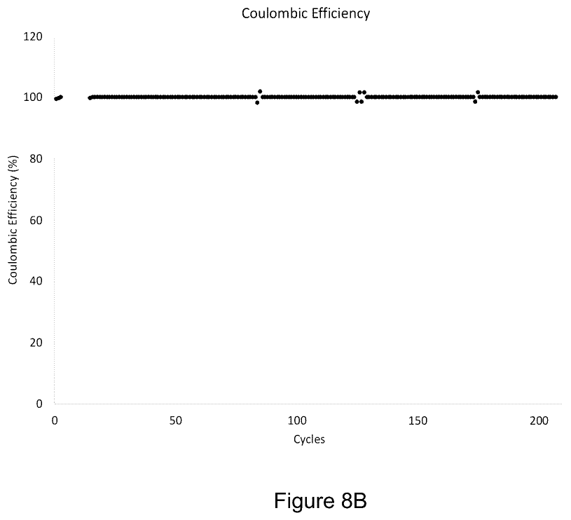

A battery comprised of a flow cell comprising two non-porous resin-filled graphite bipolar plates in contact with graphite felt separated by a Fumasep FAPQ anion exchange membrane was constructed. Chambers containing the electrodes and graphite felt were constructed from polypropylene, and the layers are sealed with Santoprene rubber, a polypropylene/EPDM elastomer. Inlets and outlets were drilled in the graphite plates such that the electrolyte solutions can flow into and out of the two chambers separated by the separator. Hard fixtures and piping were constructed from polypropylene and soft tubing used to deliver the electrolyte is made of Santoprene rubber. Flow was provided by a peristaltic pump compressing a Santoprene rubber tube. The electrolytes were dissolved in 5 mL each at 0.5M in 1.0M aqueous NaCl and stored in glass reservoirs. The chemical structures of the anolyte (PDI-tetraammonium-Cl₄) and catholyte (Ferrocene-diammonium-Cl₂) molecule used are shown below. The solutions were pumped through the flow cell at a rate sufficient for charging and discharging. This cell was charged and discharged continuously for 14 days, showing a capacity retention of 97% and total coulombic efficiency of 99.99% as shown in FIG. 8A and FIG. 8B respectively. This example demonstrates the stability of the electrolyte solutions in contact with these non-highly chemical-resistant materials.

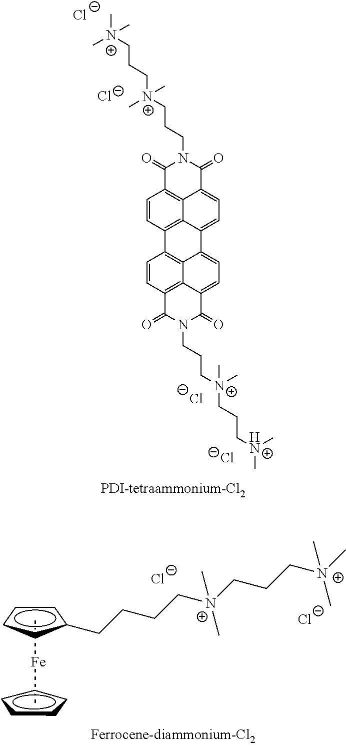

### Example 6: Perylene Diimide Molecules in 2-Electron Reduced State are Compatible with Non-Highly Chemical Resistant Materials

In a battery analogous to Example 5, the anolyte was brought to a high state of charge in one side of a glass H-cell equipped with carbon felt electrodes with platinum charge collectors. The anolyte solution was separated from the catholyte by a Selemion ion exchange membrane. After charging, the anolyte material was removed from the electrochemical cell and aliquots of this solution were placed in glass sample vials in contact with samples of different materials such that the total mass of each material was far greater than the total mass of charged electrolyte molecule in the sample. At high states of charge, the anolyte is a deep purple color while the uncharged anolyte is bright red. This difference in color provides a straightforward way to ascertain relative the state of charge of any anolyte solution. After five months of contact the anolyte samples in contact with polypropylene, polyurethane, polyethylene, Santoprene rubber and a control sample of anolyte solution only all remained purple in color, indicating no or incomplete quenching of the radical species and confirming the stability of the anolyte solution in contact with these materials.

### Example 7: HPLC Experiments to Assess Chemical Stability

In this example, the compatibility of the battery materials is assessed via High Performance Liquid Chromatography (HPLC). Chromatographic traces of the electrolyte solutions after contact in the neutral or charged states show that there are minimal or no degradations of the material into the solvent nor degradations of the electrolyte into a new chemical species. Materials tested include: ABS, BUNA-N, EPDM, Latex, Neoprene, Nylon, polyethylene, PEEK, polycarbonate, polypropylene, polystyrene, POM, polyurethane, PVC, Santoprene, silicone, and titanium. The compatibility of the materials is summarized in Table 3.

The HPLC tests were carried out using similar procedures. An exemplary soaking experiment was conducted by mixing separately an anolyte and catholyte solution containing neutral pH water, NaCl supporting electrolyte, and PDI-tetraammonium-Cl₄ and Ferrocene-diammonium-Cl₂ respectively. A portion of these solutions were separately placed into vials, after which approximately 50 mg of test material was introduced to each vial. Another 1 mAh portion of these solutions was placed into an H-cell battery with a Selemion AMV membrane, after which it was charged fully. Once charged, the anolyte and catholyte solutions were separately placed into vials, after which approximately 50 mg of test material was introduced to each vial. Separately, a control solution of pH neutral water and NaCl was placed into a vial and approximately 50 mg of test material was added. The solutions were stored in an air-free glovebox, and continuously sampled weekly, with an aliquot removed from all of the vials and injected into an HPLC instrument for purity analysis to confirm chemical compatibility between test material and the charged anolyte and catholyte solutions, neutral anolyte and catholyte solutions, and the control solution. The chromatographic trace of the ferrocene after 14 weeks of exposure and the chromatograph of perylene diimide after 14 weeks of exposure were recorded for analysis.

Small molecule tests. Sodium besylate is a form of aromatic sulfonic acid sodium salt and represents a functional group grafted to the polystyrene backbone of the Selemion™ AMVN membrane. Dosing it in at gross excess will allow us to determine whether there are inherent stability problems with aryl sulfonates either present in, or leaching from our membrane. Sodium tosylate has the added structural motif of a benzylic carbon (the methyl group) and serves as a water-soluble test of the stability of this position, which is known to undergo radical-promoted reactions under certain conditions. Propylene carbonate and sulfolane are non-volatile solvents of interest for their viscosity-reducing properties.

### Example 8: Synthesis of Water Soluble Perylene Diimide Redox-Active Compounds

Synthetic procedures for accessing perylene diimides are described below.

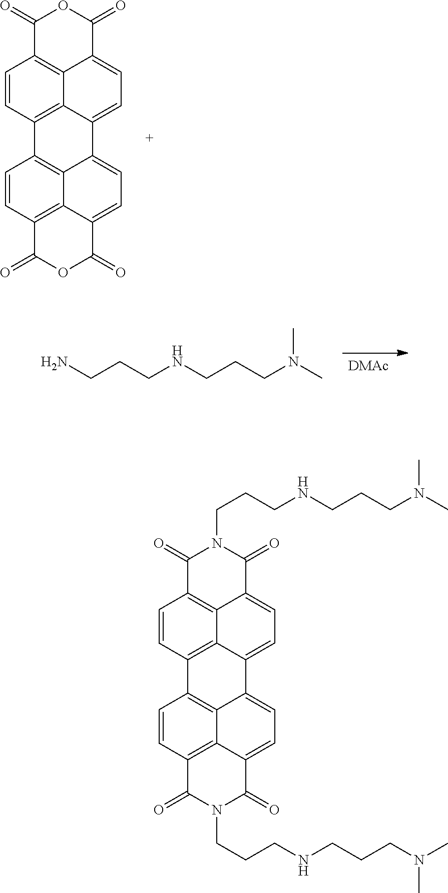

PTCDA (2.35 g, 6 mmol) was suspended in dimethylacetamide (20 mL) and stirred. N,N-Dimethyldiproylenetriamine (1.96 g, 2.22 mL, 12.3 mmol) was added and the solution was heated to 120° C. The solution at 120° C. for 12 hours, then cooled to ambient temperature. The reaction was poured into EtOAc (100 mL) and stirred vigorously. The precipitated solid was collected by filtration, washed with EtOAc, and dried under high vacuum to give the product as a deep purple/red solid (2.5 g, 3.7 mmol, 62%). 1H NMR: (CDCl3, 300 MHz) δ 1.67 (tt, J=7.1 Hz, 7.1 Hz, 4H), 1.97 (tt, J=6.8 Hz, 6.8 Hz, 4H), 2.21 (s, 12H), 2.32 (t, J=7.4 Hz, 4H), 2.71 (dt, J=18.2 Hz, 7 Hz, 8H), 4.23 (t, J=6.8 Hz, 4H), 8.13 (d, J=7.2 Hz, 4H), 8.35 (d, J=7.8 Hz, 4H).

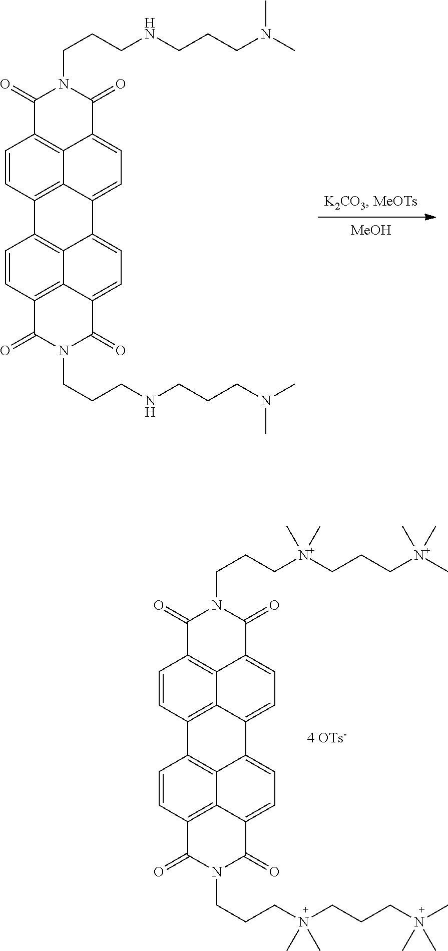

Tetraamine PDI (1.35 g, 2 mmol and potassium carbonate (0.829 g, 6 mmol) were suspended in methanol (20 mL). Methyl tosylate (4.47 g, 3.62 mL, 24 mmol) was added and the reaction was heated to 55° C. overnight. The reaction was cooled to ambient temperature, diluted with methanol (20 mL) and filtered to remove a white solid. The filtrate was concentrated to dryness by rotary evaporator and dissolved in a minimum amount of methanol. Acetone was added and a red solid precipitated from solution. The solid was isolated by filtration and dried at 55° C. under vacuum to give a dark red solid (2.05 g, 1.41 mmol, 71%). 1H NMR: (D2O, 300 MHz) δ 2.17 (s, 12H, OTs-), 2.43-2.25 (m, 8H), 3.14 (s, 18H), 3.22 (s, 12H), 3.38 (m, 4H), 3.47 (m, 4H), 3.62 (m, 4H), 4.12 (m, 4H), 7.29-7.10 (bs, 4H), 7.17 (d, J=8.2 Hz, 8H, OTs-), 7.51 (d, J=8.2 Hz, 8H, OTs-), 7.69 (bs, 4H).

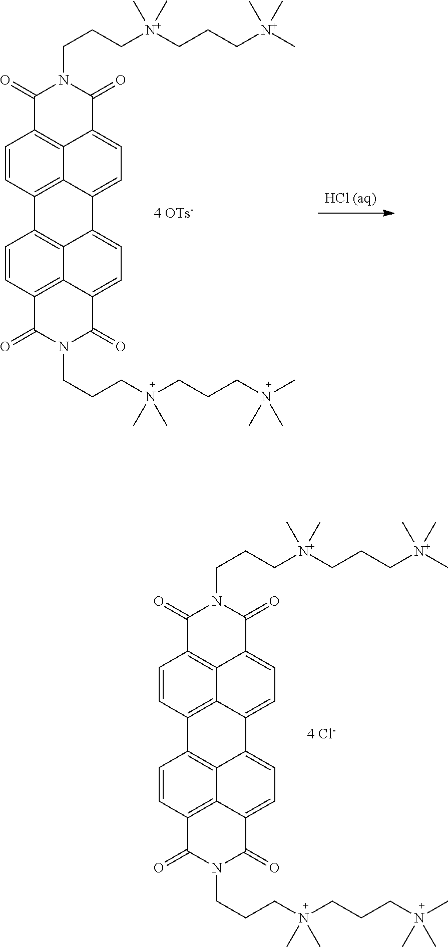

Tetraammonium tosylate PDI (2.90 g, 2 mmol) was dissolved in concentrated HCl (20 mL). The resulting mixture was heated to 85° C. for 24 hours. The reaction was cooled to ambient temperature and was diluted with isopropanol (60 mL) under vigorous stirring. The precipitated solution was collected by filtration, washed with isopropanol, and dried by at 70° C. under vacuum to give the product as a red/black solid (1.6 g, 1.77 mmol, 88%). 1H NMR: (D20, 300 MHz) δ 2.71-2.12 (bm, 8H), 3.90-2.99 (bm, 42H), 4.21 (bs, 4H), 8.39-6.96 (bm, 8H).

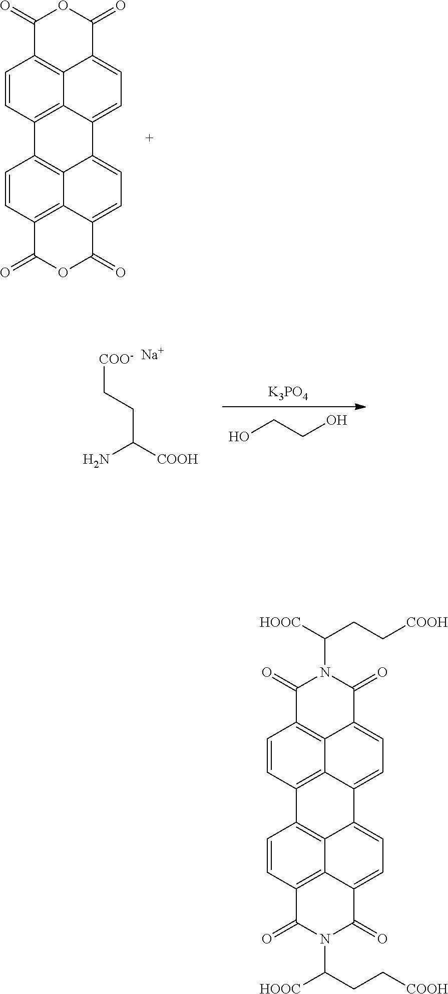

Glutamic Acid and PTCDA were suspended in DMSO. Under stirring, potassium phosphate tribasic was added and the solution was heated to 120° C. The reaction stirred for 18 hours and cooled to ambient temperature. 1 M HCl was added, and the precipitated solid was filtered to give the product as a purple/black solid (100% based on recovered starting material).

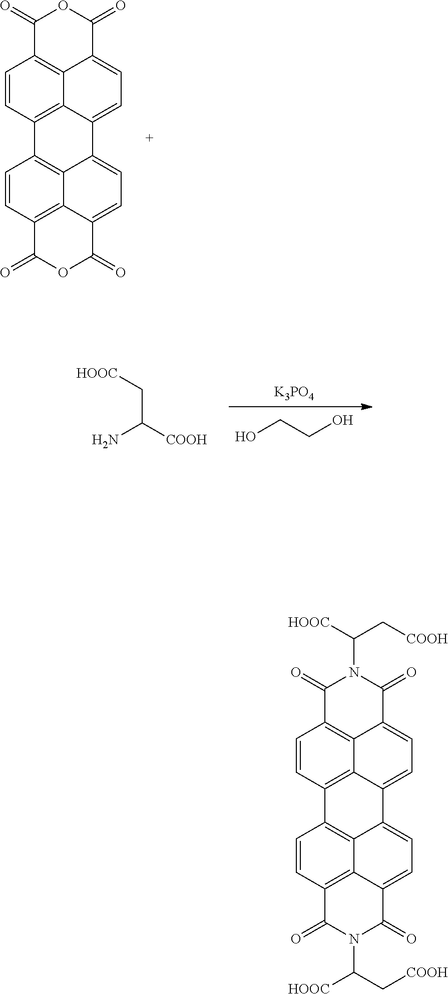

Aspartic acid (2.93 g, 22 mmol) and PTCDA (3.92 g, 10 mmol) were suspended in ethylene glycol. Potassium phosphate tribasic (9.9 g, 46 mmol) was added and the resulting solution was heated to 140° C. for 12 hours. The reaction cooled to ambient temperature and was poured into 1 M HCl (aq) (50 mL). The resulting precipitate was collected by filtration and washed with water and dried under vacuum at 55° C. to give the product as a purple solid (1.914 g, 3.07 mmol, 31%). 1H NMR: (D6-DMSO, 300 MHz) δ 2.85 (dd, J=16.6 Hz, 4.5 Hz, 2H), 3.42 (m, 2H), 6.08-6.01 (m, 2H), 8.43-7.67 (bm, 8H).

### Example 9: Synthesis of Water Soluble Ferrocene-Based Redox Active Compounds

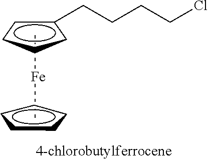

Ferrocene (50 g, 269 mmol, 1.1 equivalents) was added to a 3-L 3-neck round-bottom flask charged with a stir bar and equipped with an addition funnel and a gas outlet leading to a bubbler filled with saturated aqueous NaHCO₃. The apparatus was purged with dry nitrogen gas. Dichloromethane (600 mL) was added and stirred to dissolve the ferrocene. The mixture was cooled to 0° C. in an ice water bath. In a separate round-bottom flask charged with a stir bar, aluminum trichloride (35.9 g, 269 mmol, 1.1 equivalents) was added and the flask was purged with dry nitrogen. Dichloromethane (600 mL) was added and stirred to suspend the aluminum trichloride. 4-Chlorobutyryl chloride (34.4 g, 245.5 mmol, 1.0 equivalents) was added dropwise to the aluminum trichloride suspension and stirred until dissolution of the aluminum trichloride stops. The acid chloride mixture was decanted from undissolved aluminum trichloride into the addition funnel of the reaction apparatus. This solution was added slowly to the ferrocene solution in the reaction vessel at 0° C. taking care not to allow the mixture to heat above 10° C. The mixture was then stirred for 3 hours while the bath was slowly warmed to ambient temperature. The vessel was once again cooled to 0° C. In a separate flask, sodium borohydride (18.5 g, 489 mmol, 2.0 equivalents) was combined with diglyme (70 mL) and dichloromethane (20 mL) under nitrogen atmosphere. This mixture was transferred to the addition funnel of the reaction vessel and added dropwise to the reaction mixture. The reaction was allowed to stir 18 hours at ambient temperature. Reaction was quenched at 0° C. by the addition of 1M aqueous ammonium chloride (100 mL) followed by water (100 mL) and a saturated aqueous solution of potassium sodium tartrate (400 mL). After the evolution of gas stopped, the organic layer was collected and the aqueous layer was extracted with dichloromethane (3 washes, 100 mL each), solvent was removed from the combined organic layers and the resulting liquid was dissolved in 500 mL of hexanes. The hexanes layer was washed with water (8 washes, 200 mL each) to remove diglyme, and dried by shaking with saturated aqueous sodium chloride solution. The organic layer was further dried over solid magnesium sulfate (100 g), filtered, and the solvent was removed to yield the desired product as an orange oil (60 g, 88%). 1H NMR (300 MHz, Chloroform-d) δ(ppm) 4.11 (overlap, 9H), 3.58 (t, J=7.0 Hz, 2H), 2.40 (t, J=7.8 Hz, 2H), 1.84 (dt, J=6.8, 7.8, 2H), 1.71 (dt, J=6.8, 7.0, 2H).

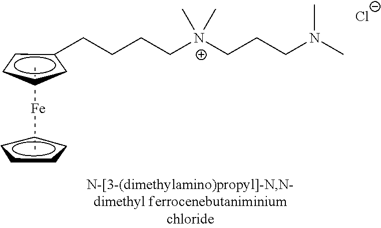

4-Chlorobutylferrocene (75 g, 276.6 mmol, 1.0 equivalent), N,N,N′,N′-tetramethyl-1,3-propanediamine (105 g, 814 mmol, 3 equivalents) and acetonitrile (500 mL) were combined in a round-bottom flask and heated to 60° C. for 12 hours. The mixture was cooled and washed with hexanes (5 washes 150 mL per wash) the acetonitrile layer was reserved. The combined hexanes layers were evaporated to yield an orange liquid to which N,N,N′,N′-tetramethyl-1,3-propanediamine (50 g, 388 mmol, 1.43 equivalents) and acetonitrile (250 mL) were added in a round-bottom flask and the mix was heated to 60° C. for 12 hours. After cooling, the acetonitrile solution was washed with hexanes (5 washes 150 mL per wash) and the acetonitrile layer was combined with the reserved layer from the previous workup. The solvent was removed from the combined layers to yield an orange oil which was triturated with sonication with diethylether (200 mL). The ether was decanted off and volatiles were further removed under vacuum yielding the product as a very viscous orange oil (97 g, 88%) 1H NMR (300 MHz, Chloroform-d) δ(ppm) 4.08 (overlap, 9H), 3.53 (overlap, 4H), 3.40 (s, 6H), 2.44 (t, J=7.9, 2H), 2.36 (t, J=6.0, 2H), 2.19 (s, 6H), 1.83 (m, 2H), 1.70 (m, 2H), 1.58 (m, 2H).

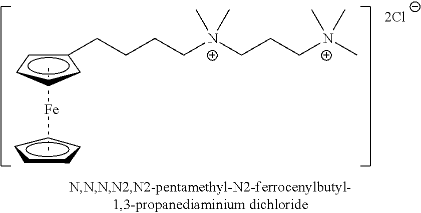

N-[3-(dimethylamino)propyl]-N,N-dimethyl ferrocenebutaniminium chloride (97 g, 238 mmol, 1.0 equivalents) was dissolved in methanol (1000 mL). Iodomethane (101 g, 715.3 mmol, 3.0 equivalents) was added slowly via syringe and the mix was stirred at ambient temperature for 12 hours. Solvent and unreacted iodomethane were removed under reduced pressure and the residue was dissolved in water (200 mL) and stirred for one hour with Amberlite IRA-400 ion exchange resin beads (200 cm3) at which point the resin was filtered off and the solution was passed through a column of Amberlite IRA-400 ion exchange resin beads (500 cm3) with water as the eluent. Water was removed from the resulting solution to yield the product as a very viscous orange oil which crystalizes upon standing (94.4 g, 87%) 1H NMR (300 MHz, deuterium oxide) δ(ppm) 4.20 (overlap 9H), 3.34 (overlap, 6H), 3.16 (s, 9H), 3.09 (s, 6H), 2.42 (t, J=7.0, 2H), 2.27 (m, 2H), 1.76 (m, 2H), 1.55 (m, 2H).

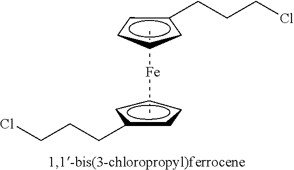

Ferrocene (10.0 g, 53.4 mmol, 1.00 equivalent) was added to a 1-L 3-neck round-bottom flask charged with a stir bar and equipped with an addition funnel, a reflux condenser, and a gas outlet leading to a bubbler filled with saturated aqueous NaHCO₃. The apparatus was purged with dry nitrogen gas. Dichloromethane (100 mL) was added and stirred to dissolve the ferrocene. The mixture was cooled to 0° C. in an ice water bath. In a separate round-bottom flask charged with a stir bar, aluminum trichloride (18.0 g, 134 mmol, 2.50 equivalents) was added and the flask was purged with dry nitrogen. Dichloromethane (100 mL) was added and stirred to suspend the aluminum trichloride. 3-Chloropropionyl chloride (17.0 g, 134 mmol, 2.50 equivalents) was added dropwise to the aluminum trichloride suspension and stirred until dissolution of the aluminum trichloride stops. The acid chloride mixture was decanted from undissolved aluminum trichloride into the addition funnel of the reaction apparatus. This solution was added slowly to the ferrocene solution in the reaction vessel at 0° C. taking care not to allow the mixture to heat above 10° C. The mixture was then heated to reflux for 16 hours. The vessel was once again cooled to 0° C. In a separate flask, sodium borohydride (8.00 g, 214 mmol, 4.00 equivalents) was combined with diglyme (40 mL) and dichloromethane (20 mL) under nitrogen atmosphere. This mixture was transferred to the addition funnel of the reaction vessel and added dropwise to the reaction mixture. The reaction was allowed to stir 18 hours at ambient temperature. Reaction was quenched at 0° C. by the addition of 1M aqueous ammonium chloride (100 mL) followed by water (100 mL) and a saturated aqueous solution of potassium sodium tartrate (100 mL). After the evolution of gas stopped, the organic layer was collected and the aqueous layer was extracted with dichloromethane (3 washes, 50 mL each), solvent was removed from the combined organic layers and the resulting liquid was dissolved in 200 mL of hexanes. The hexanes layer was washed with water (8 washes, 200 mL each) to remove diglyme, and dried by shaking with saturated aqueous sodium chloride solution. The organic layer was further dried over solid magnesium sulfate (50 g), filtered, and the solvent was removed to yield the desired product X as an orange oil (13 g, 72%). 1H NMR (300 MHz, Chloroform-d) δ(ppm) 4.10 (overlap, 8H), 3.58 (t, J=6.2 Hz, 4H), 2.50 (t, J=7.1 Hz, 4H), 1.98 (tt, J=6.2 Hz, 7.1 Hz, 4H).

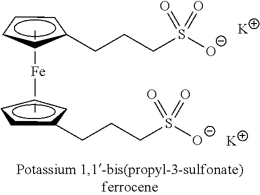

1,1′-bis(3-chloropropyl)ferrocene (1.5 g, 4.4 mmol, 1.0 equivalent), potassium sulfite (8.4 g, 53 mmol, 12 equivalents), and water (100 mL) were added to a 250-mL round bottom flask equipped with a condenser. The mixture was heated to reflux for 4 days during which time the immiscible ferrocene starting material slowly disappears as it is converted into water soluble products. The mixture was cooled and extracted with ethyl acetate (3 washes, 200 mL) to remove starting material. Water was removed from the aqueous layer and methanol (100 mL) was added. This mixture was filtered, and the methanol was removed by distillation. The resulting yellow solid was washed with copious isopropanol to remove acetate salts. After drying the product is obtained as a yellow powder (1.2 g, 54%). 1H NMR (300 MHz, deuterium oxide) δ(ppm) 4.06 (overlap, 8H), 2.84 (t, J=7.8 Hz, 4H), 2.40 (t, J=7.6 Hz, 4H), 1.98 (tt, J=7.8 Hz, 7.6 Hz, 4H).

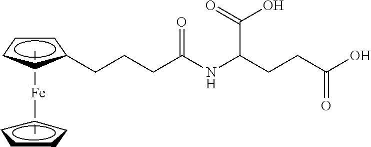

Ferrocene butane carboxylic acid (1.00 grams, 3.67 mmol) and N-hydroxysuccinimide (0.423 g, 3.67 mmol) were dissolved in DCM (18.5 mL) and the resulting mixture was stirred at ambient temperature. EDC (0.733 g, 4.04 mmol) was added, and the mixture was stirred at ambient temperature overnight. To a solution of glutamic acid (1.08 g, 7.3 mmol) in isopropanol (10 mL), triethylamine (2.02 g, 2.78 mL, 20 mmol) was added. After the dissolution of the glutamic acid, the crude solution of ferrocene N-hydroxysuccinimide activated ester was added to the glutamic acid mixture. The resulting mixture stirred 12 hours and ambient temperature, and was then heated to 90 degrees C. for 12 hours. The reaction mixture was quenched by the addition of 1 M NaOH, and washed with ethyl acetate. The aqueous layer was acidified with 1 M HCl and extracted with ethyl acetate. The ethyl acetate layer was washed with 0.01 M NaOH, and the aqueous wash was discarded. The organic layer was then extracted with two portions of 0.1 M NaOH. The aqueous extracts were combined, acidified with 1 M HCl, and extracted with EtOAc. The organic extract was washed with water and brine, dried over magnesium sulfate, filtered and concentrated to give the product as a yellow solid (0.200 g, 0.5 mmol, 14%). 1H NMR: (d-DMSO, 300 MHz) δ 1.83-1.63 (m, 4H), 2.03-1.90 (m, 1H), 2.14 (t, J=7.2 Hz, 2H), 2.32-2.23 (m, 4H), 4.05-4.01 (m, 1H), 4.08 (d, J=1.3 Hz, 2H), 4.1 (s, 5H), 4.21 (dt, J=8.5 Hz, 5.0 Hz, 1H), 8.08 d, J=7.5 Hz, 1H.

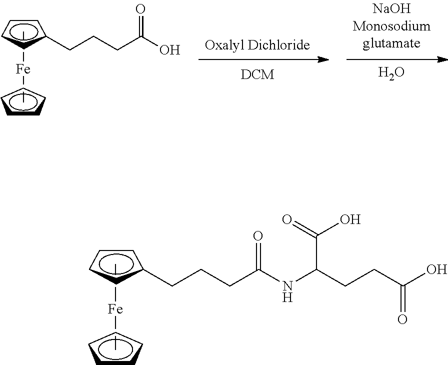

Synthesis of N-(4-ferrocenylbutanoyl)-L-glutamic acid. A 1-L round bottom flask was charged with 4-Ferrocenylbutanoic acid (68.0 g, 250 mmol, 1.0 equiv.). DCM (125 mL) and a stir bar. Under a positive pressure of N2 (g) and vigorous stirring, oxalyl chloride (23.6 mL, 275 mmol, 23.6 mL, 1.20 equiv.) was slowly added dropwise, being careful of gas evolution. The dark brown solution was stirred at 25° C. until gas evolution slowed (˜5 min). The reaction was then further heated to 40° C. and allowed to react for 1 hour. The solvent was removed by rotary evaporation.

A solution of sodium L-glutamate monohydrate (143 g, 763 mmol, 3.05 equiv.), sodium hydroxide (30.0 g, 750 mol, 3.0 equiv.), and water (68 mL) was prepared at 100° C. Once all solids dissolved, the previously prepared ferrocene acid chloride was added quickly to the stirring glutamate solution. During addition of acid chloride, the formation of a brown precipitate was observed. An extra ˜50 mL of water was added to aid in stirring of the reaction. Reaction was allowed to react at 100° C. for ˜5 min. Reaction was cooled to room temperature and water was added to completely dissolve all solids. NaCl (s) was added to completely saturate the aqueous solution. Resulting aqueous solution was titrated to a pH of 5.8 with HCl (6 M). Impurities were extracted with MeCN (4×200 mL). Resulting aqueous layer was further titrated to a pH of 3 with HCl (6 M). MeCN was used to extract the product from the aqueous layer until the resulting aqueous layer was a blue color (3×˜200 mL). ˜200 mL of silica and ˜200 mL of anhydrous sodium sulfate was added to the acetonitrile solution. The acetonitrile slurry was allowed to stir for 30 minutes at room temperature. The slurry was filtered through a fritted glass filter and the acetonitrile solution was collected. The dark red solution was concentrated by rotary evaporation. The resulting dark red oil was further concentrated in vacuo to yield a dark yellow-brown solid (53.8 g, 113 mmol, 45% yield, 84% purity).

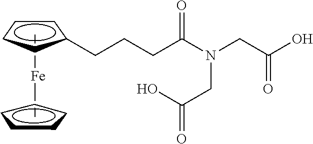

Synthesis of N-butanoyl-4-ferrocenyl iminodiacetic acid. Ferrocene butyric acid (10 g, 0.037 mol) was dissolved in DCM (50 mL), and a few drops of DMF were added. Oxalyl chloride (5.13 g, 3.47 mL, 0.40 mol) was added dropwise over 5 minutes and the resulting mixture stirred for 45 minutes. The solvent was removed by rotovap to give the product as a red oil. A solution of iminodiacetic acid (9.78 g, 0.074 mol) in 6 M NaOH (24 mL) was diluted with acetone (12 mL). The solution was diluted with water until the mixture became homogeneous (30 mL). The iminodiacetic acid solution and the neat acid chloride were simultaneously pushed through a static mixer, and the resulting reaction mixture was stirred for 20 minutes. The reaction mixture was diluted to 150 mL. The pH was adjusted to 4.9 with 2 M HCl and the solution was extracted with two portions of DCM. The organic layers were discarded. The aqueous layer was adjusted to pH 2.8 with 6 M HCl and under vigorous stirring a solid precipitated. The solid was collected by filtration, washed with water, 0.1 M HCl, and water twice more. The solid was dried to give the product as a gray-yellow solid (7.74 g, 0.02 mol, 54%). 1H NMR: (d-DMSO, 500 MHz) δ 1.72-1.65 (m, 2H), 2.29-2.24 (m, 4H), 3.96 (s, 1H), 4.03 (t, J=1.75 Hz, 2H), 4.075 (t, J=1.8 Hz, 1H), 4.11 (s, 5H), 4.1 (s, 5H), 4.14-4.12 (bs, 2H).

### Example 10: H-cell Experiments Showing Stability of Anionic Water Soluble Perylene Diimide and Ferrocene Electrolyte Solutions

These experiments show that that the disclosed anionic electrolyte solutions are compatible in the charged and uncharged state. This static cell experimental setup allows for the accurate measurement of coulombic efficiency to analyze the electrochemical and physical compatibility of the charged electrolyte solution with a cell fabrication material. A high coulombic efficiency shows that the electrons placed into the organic charge storage electrolyte upon charging are returned upon discharge, meaning that the electrolyte did not electrochemically or physically react with anything, including the cell fabrication material, while in the charged state and thereby quench the charge.

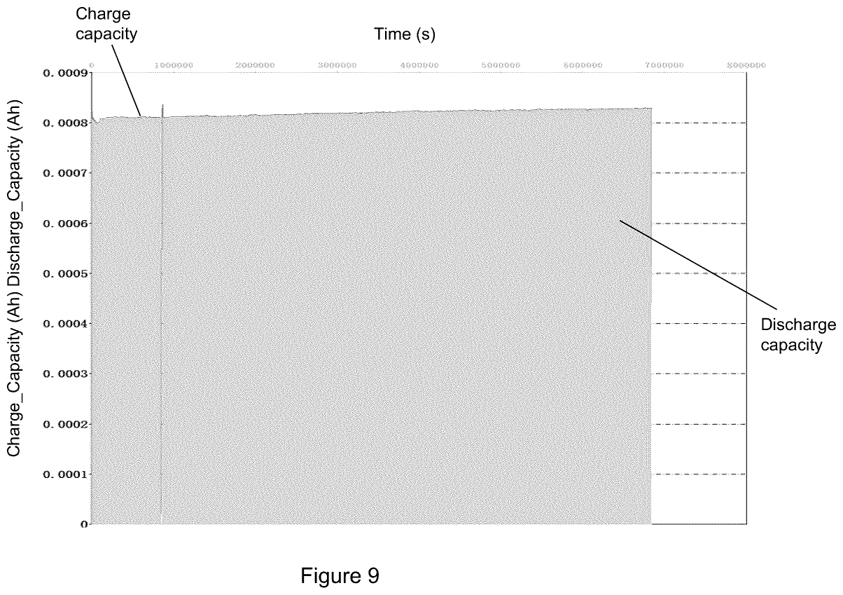

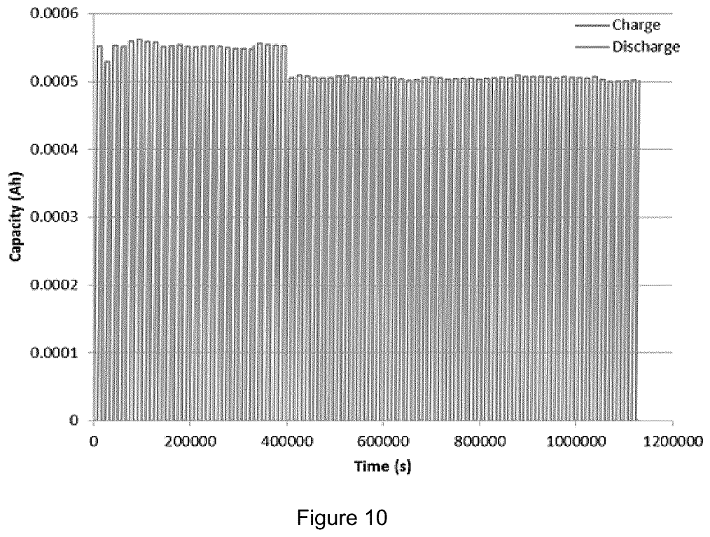

An exemplary 1 mAh H-cell was fabricated using glutamic-PDI in the anolyte half-cell and bis-propyl-sulfonate ferrocene in the catholyte half-cell. The structures of these molecules are shown below. Cycling of glutamic-PDI and bis-propylsulfonate ferrocene is shown in FIG. 9. The cells were comprised of glass and the membrane was Selemion™ CMV. Each half cell was mixed with PTFE stir bars, while the electrodes were carbon felt. The coulombic efficiency of a set of cycles was measured. Cycles 10-40 showed >99.9% average coulombic efficiency, indicating that both the anolyte and catholyte electrolyte solutions are stable, since there is minimal electrochemical or physical degradation in the charged state. The capacity remained stable as well.

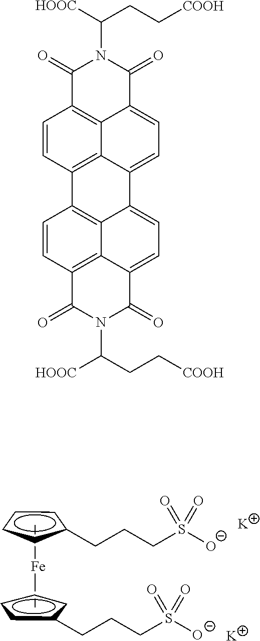

An exemplary 1 mAh H-cell was fabricated using glutamic-PDI in the anolyte half-cell and glutamic-amide ferrocene in the catholyte half-cell. The structures of these molecules are shown below. Cycling of glutamic-PDI and bis-propylsulfonate ferrocene is shown in FIG. 10. The cells were comprised of glass and the membrane was Selemion CMV. Each half cell was mixed with PTFE stir bars, while the electrodes were carbon felt. The coulombic efficiency of a set of cycles was measured. Cycles 10-40 showed 99.9% average coulombic efficiency, indicating that both the anolyte and catholyte electrolyte solutions are stable, since there is minimal electrochemical or physical degradation in the charged state. The capacity remained stable as well.

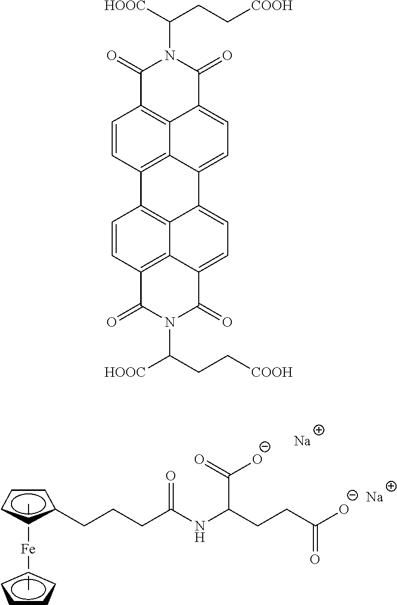

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to +0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A redox flow battery comprising:
a first half-cell containing a first aqueous solution comprising a first electrode and an anolyte; wherein the anolyte comprises a perylene diimide compound;
a second half-cell containing a second electrode and a second aqueous solution comprising a catholyte; and
a separator interposed between the first half-cell and the second half cell;
wherein the interior surfaces of the first half-cell that contacts the first aqueous solution and the second half-cell that contacts second aqueous solution comprise one or more non-highly chemical-resistant materials.

2. The redox flow battery of claim 1, wherein the non-fluorinated polymer is selected from the group consisting of: a polyolefin, a polyether, a polyketone, a polyamide, a polyurea, a natural rubber, and a combination thereof.

3. The redox flow battery of claim 1, wherein the non-fluorinated polymer is a copolymer of two or more polymers selected from the group consisting of: a polyolefin, a polyether, a polyketone, a polyamide, a polyurea, and a natural rubber.

4. The redox flow battery of claim 1, wherein the non-fluorinated polymer is selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (Santoprene), and a combination thereof.

5. The redox flow battery of claim 1, wherein the non-fluorinated polymer is a copolymer of two or more polymers selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), and EPDM polypropylene matrix elastomer (Santoprene).

6. The redox flow battery of claim 1, wherein the first half-cell comprises a first bipolar plate and the second half-cell comprises a second bipolar plate, wherein the first bipolar plate comprises a composite material of graphite and a polymer.

7. The redox flow battery of claim 6, wherein the composite material is resin-filled graphite; or graphite in a thermoset resin matrix.

8. The redox flow battery of claim 6, wherein the polymer of the composite material is polyethylene or polypropylene.

9. The redox flow battery of claim 1, further comprising a gasket separating the reaction vessel from the first bipolar plate, wherein the gasket comprises a non-highly chemical-resistant elastomeric material; wherein the non-highly chemical-resistant elastomeric material is selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (Santoprene), and a combination thereof.

10. The redox flow battery of claim 1, wherein the separator comprises a polystyrene-based ion-exchange membrane.

11. The redox flow battery of claim 1, further comprising a supply line positioned outside the first half cell to supply the anolyte to the first half cell, wherein the supply line comprises a non-highly chemical-resistant elastomeric material; wherein the non-highly chemical-resistant elastomeric material is selected from the group consisting of: ethylene propylene diene monomer rubber (EPDM), polychloroprene (Neoprene), polyamide (nylon), polyether ether ketone (PEEK), polyoxymethylene (POM), polyvinyl chloride (PVC), sodium benzene sulfonate (sodium besylate), sodium 4-toluene sulfonate (sodium tosylate), propylene carbonate, sulfolane, acrylonitrile butadiene rubber (BUNA-N), natural latex rubber, polyethylene (PE), polymethylmethacrylate (PMMA), polypropylene (PP), polyurethane (PUR), EPDM polypropylene matrix elastomer (Santoprene), and a combination thereof.

12. The redox flow battery of claim 1, wherein the perylene diimide compound has a Formula (I): 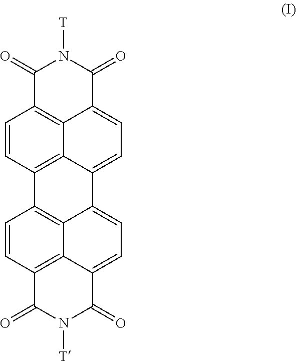
or a salt thereof, wherein:
T is -(L-G)ₙ-X;
T′ is H, (C₁-C₆)alkyl, or -(L-G)ₙ-X;
L is —(C₂-C₅)-alkyl optionally substituted with OH, OCH₃, halo 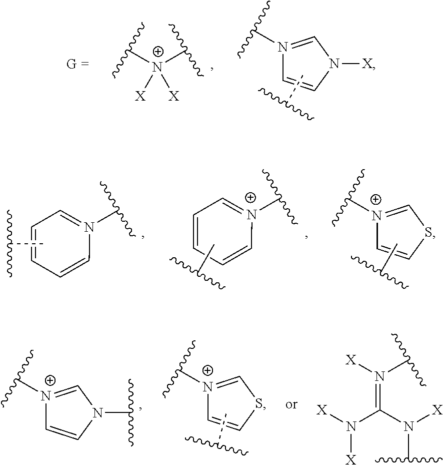
each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20.

13. The redox flow battery of claim 12, wherein T and T′ are each independently -(L-G)ₙ-X.

14. The redox flow battery of claim 12, wherein L is selected from the group consisting of: unsubstituted —(C₂-C₅)-alkyl, ethyl, and propyl.

15. The redox flow battery of claim 12, wherein n is 2, 3, or 4.

16. The redox flow battery of claim 12, wherein G is 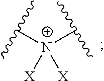
wherein X is H, methyl, —CH₂CH₂OH, or —(C₁-C₆)-alkyl.

17. The redox flow battery of claim 12, the compound of Formula (I) is:

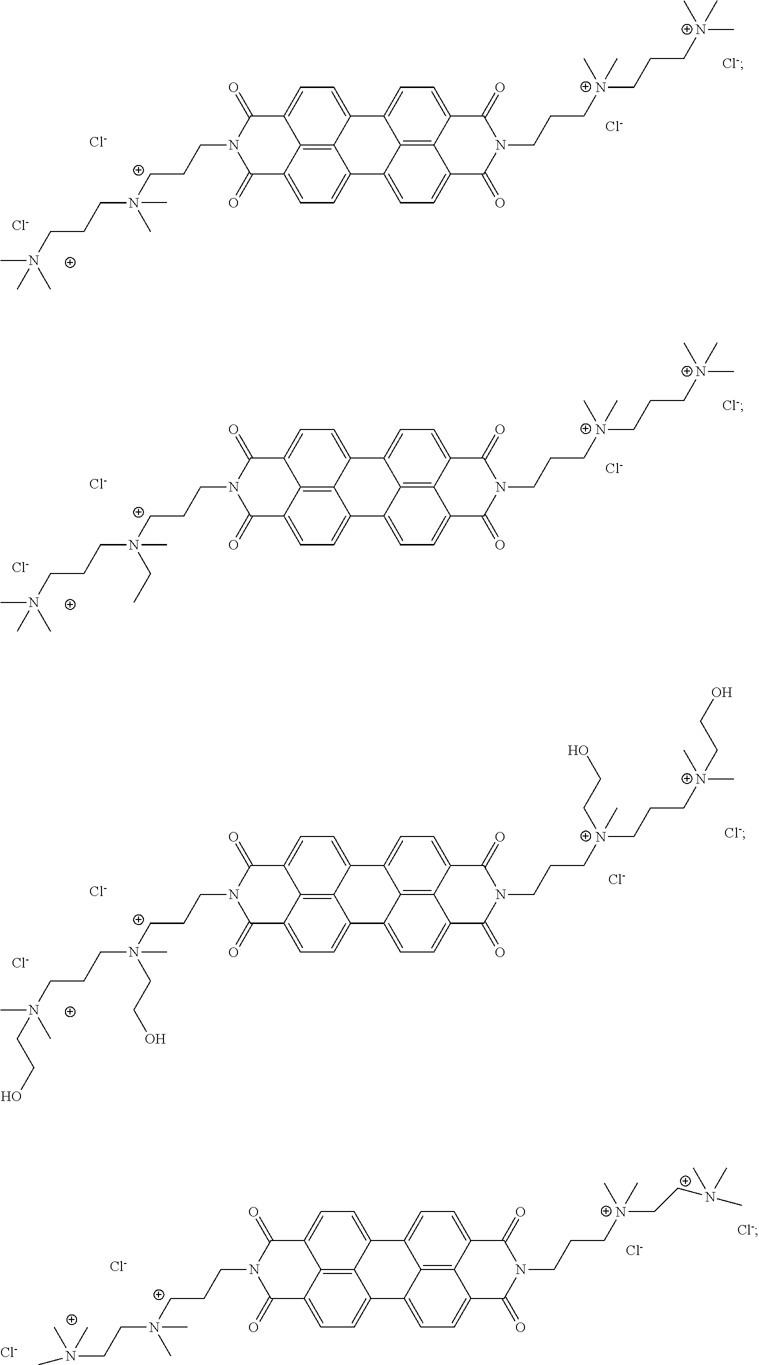

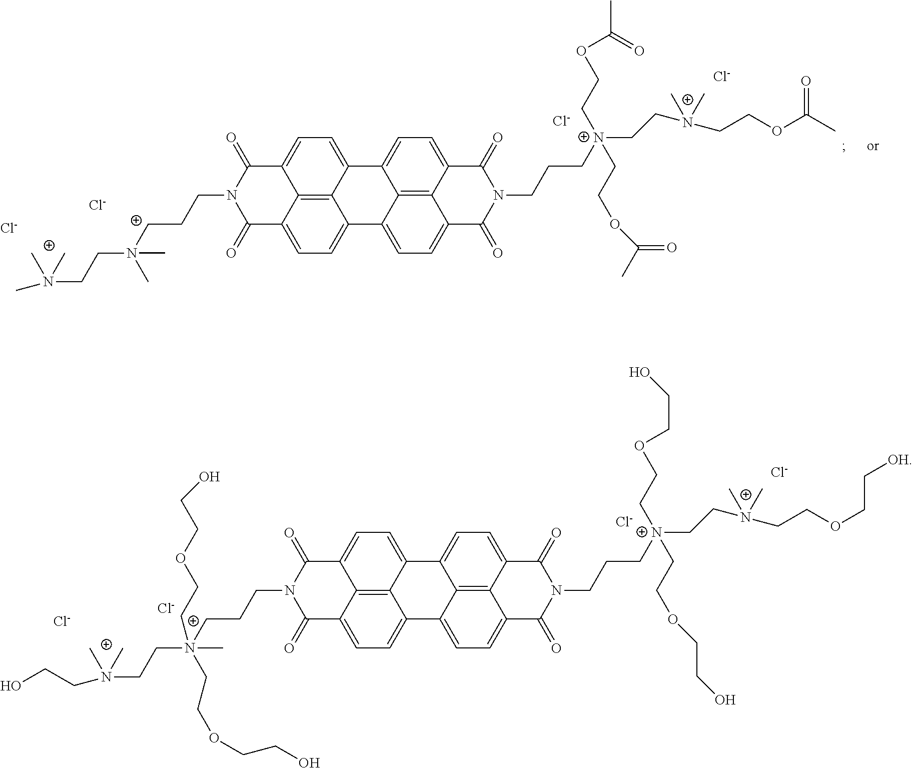

18. The redox flow battery of claim 1, wherein the perylene diimide compound has a Formula (II): 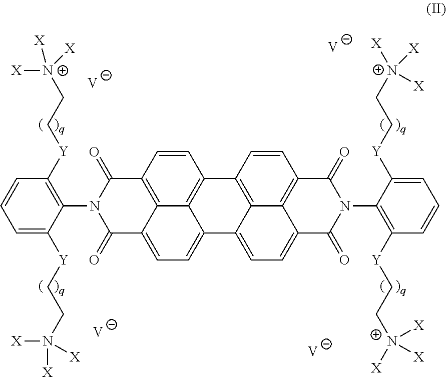
wherein
each Y is independently —O—, —S— or —NH—;
each q is independently 1 to 8; and
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂; and
each V is a counterion.

19. The redox flow battery of claim 1, wherein the perylene diimide compound has a Formula (III): 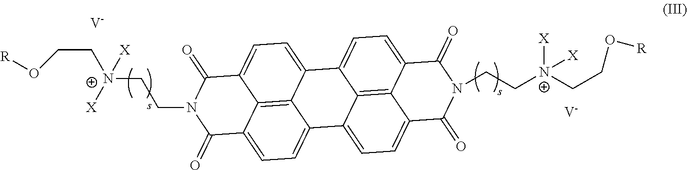
wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently-OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ—O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-6)alkyl; and
each V⁻ is a counterion.

20. The compound of claim 13, wherein the compound of Formula (III) is:

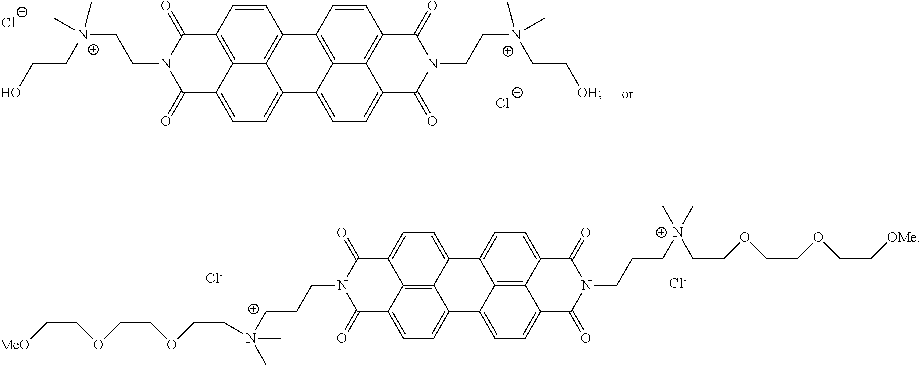

21. The redox flow battery of claim 1, wherein the perylene diimide compound has a Formula (IV): 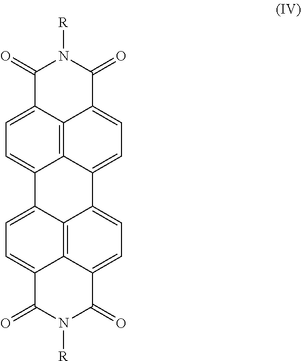
wherein
R is

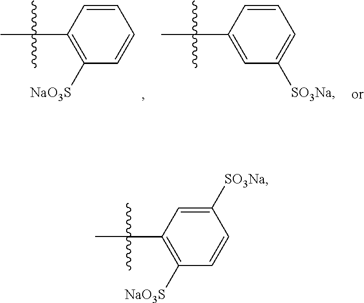

22. The redox flow battery of claim 1, wherein the perylene diimide compound has a Formula (V): 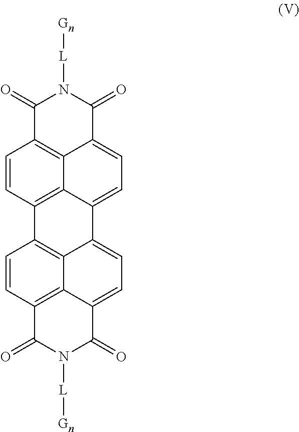
or a salt thereof, wherein
L is —(C₁-C₆)-alkyl;
each G is 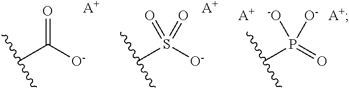
A is a cation; and
n=1 to 5.

23. The redox flow battery of claim 22, wherein L is substituted with OH, OCH₃, and halo; wherein each A is lithium, sodium, potassium, or ammonium.

24. The redox flow battery of claim 22, wherein L-Gₙ group has at least one chiral center.

25. The redox flow battery of claim 22, wherein the compound of Formula (V) is selected from the group consisting of:

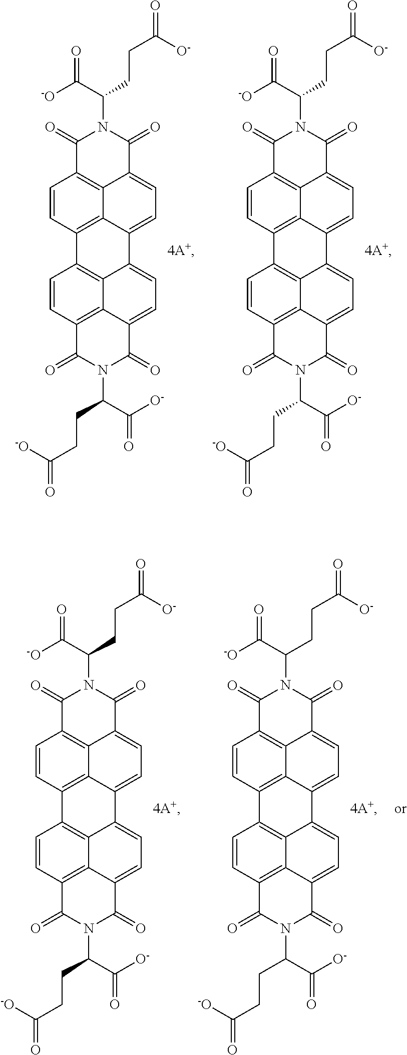

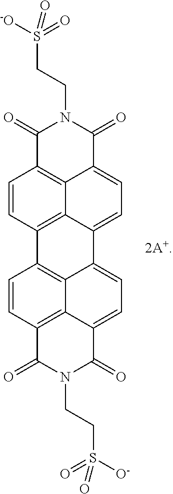

26. The redox flow battery of claim 25, wherein A is lithium, sodium, potassium, or ammonium.

27. The redox flow battery of claim 1, wherein the catholyte comprises a second compound with a ferrocene moiety, wherein the second compound has a formula selected from the group consisting of:

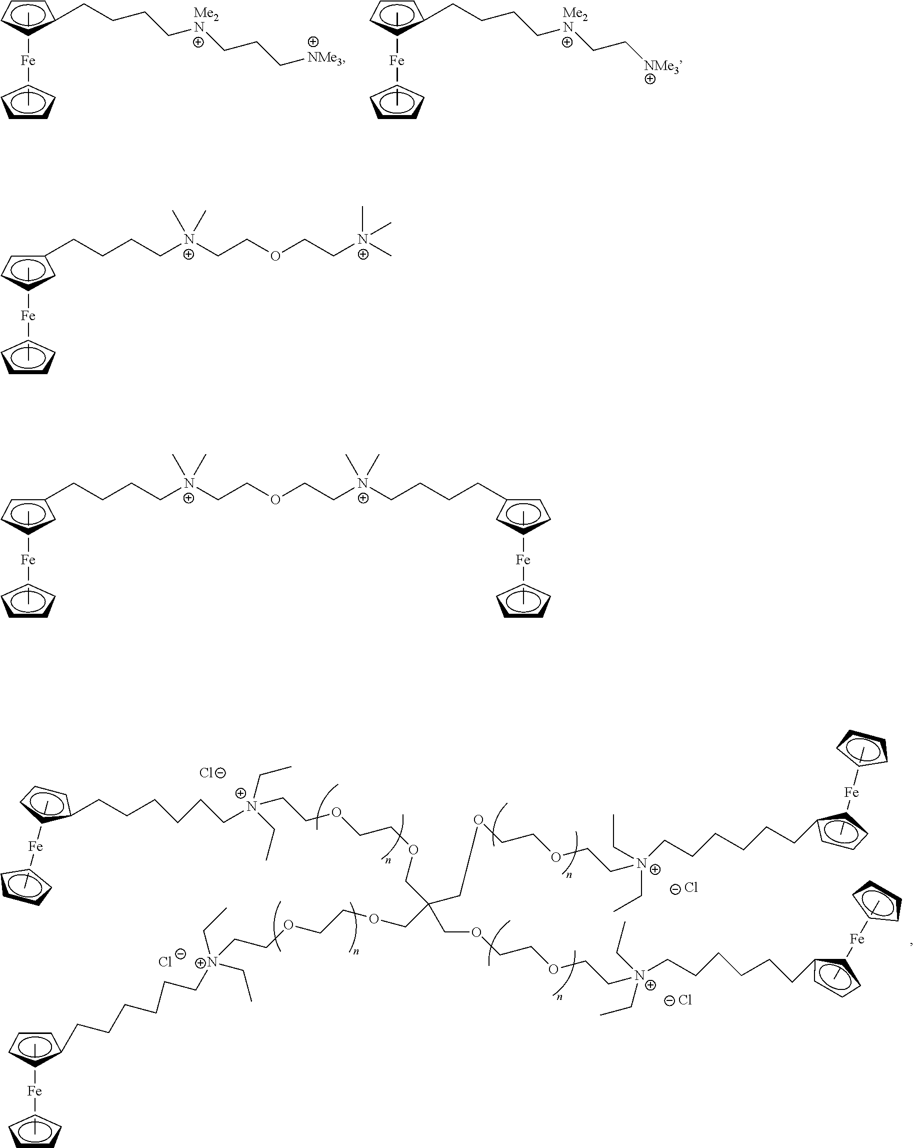

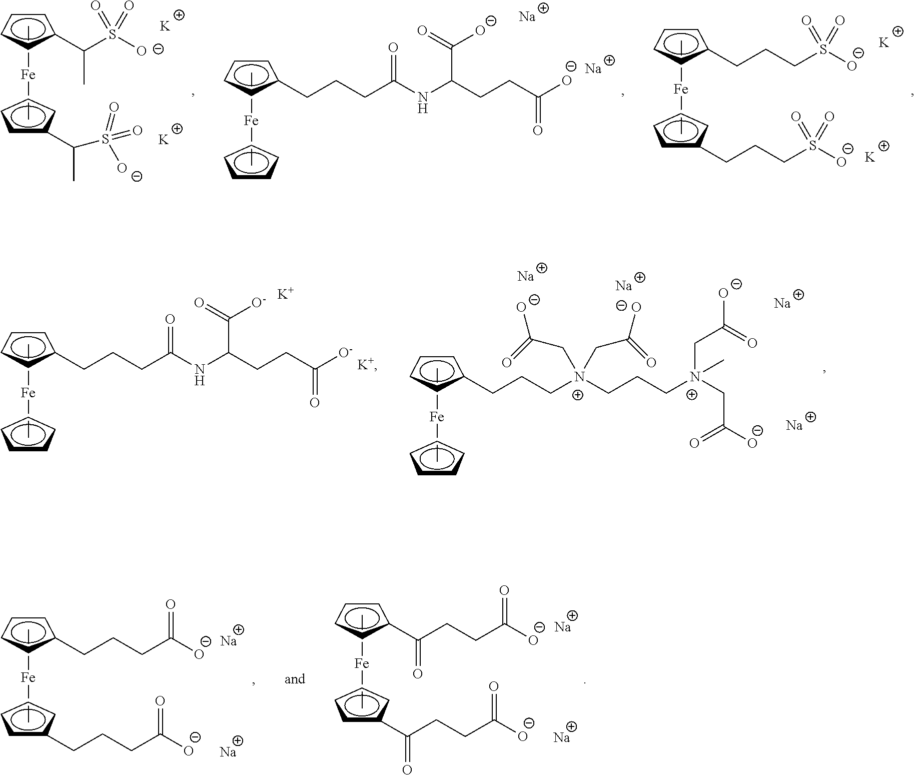

28. The redox flow battery of claim 1, wherein the catholyte comprises a second compound with a ferrocene moiety, wherein the second compound has a formula Formula (VI): 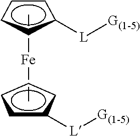
wherein:
L is —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
L′ is —H, —(C₁-C₁₀)-alkyl, —(C₁-C₆)-alkenyl, —(C₁-C₆)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl —(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
G is selected from the group consisting of 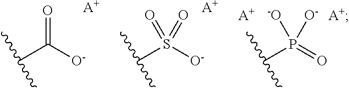
G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl.

29. The redox flow battery of claim 28, wherein L is substituted by at least one group selected from the group consisting of: G, —OH, —OCH₃, and -halo; wherein L′ is substituted at least one group selected from the group consisting of: G, —OH, —OCH₃, and -halo; wherein R² is substituted by at least one G.

30. The redox flow battery of claim 28, wherein the compound of Formula (VI) is [chemical structure]
